(19) United States
(12) Patent Application Publication
(10) Pub. No.: US 2009/0226057 A1
(43) Pub. Date: Sep. 10, 2009

(54) Segmentation device and method

(76) Inventors: Adi Mashiach, Tel Aviv (IL); Ori Hay, Moshav Aviel (IL); Gil Farkash, Binyamina (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/073,288

(22) Filed: Mar. 4, 2008

(51) Int. Cl. G06K 9/00

(52) U.S. Cl. 382/128

(57) ABSTRACT

There is provided a method of medical imaging of a structure that includes creating a three dimensional image of the structure and processing the image to enhance image quality such that images with an attenuation value below a threshold value result in recognizable image, thereby identifying the structure.

### FIELD

The disclosure relates to imaging devices.

### BACKGROUND

Imaging devices used in medical applications frequently require a subject to take a contrast material, which may serve to highlight the patient's organs, or other internal body parts, for improved image acquisition. Contrast material may be administered by injection, for example, when imaging tubular organs such as blood vessels, where the contrast material may be injected into the circulatory system so that the shape, path or outline of a vessel is highlighted. Contrast materials may also be injected into the circulatory system to highlight internal organs in the body such as the kidneys, liver, brain, thyroids, and other organs which receive blood flow. Contrast materials may also be injected directly into body parts such as the abdomen and other body cavities, and to areas of the spine. Contrast material may also be administered orally, or optionally rectally, to highlight, for example, an alimentary canal and/or excretory organs.

Use of a contrast material may be accompanied by a relatively high degree of risk to the subject. The subject may experience severe, and in some cases, potentially life threatening, allergic reactions to the contrast material. Furthermore, the contrast material may cause organ damage, such as, for example, kidney damage, particularly if the subject suffers from a renal insufficiency, diabetes, and/or a reduced intravascular volume. The relatively high risk of using contrast material, together with its relatively high cost, warrants a reduction in the use of contrast material in medical imaging applications.

### SUMMARY

According to some embodiments, there is provided a method of medical imaging of a structure that includes creating a three dimensional texture image data of a structure and processing the image data to enhance image quality such that images with an attenuation value below a threshold value result in recognizable images, thereby identifying the structure.

According to some embodiments, the method of medical imaging includes a method of segmentation. The method of segmentation may be specifically adapted to various imaging processes and imaging devices, such as for example, CT imager and CT images. The method of segmentation may operate and grow in 3-dimensional (3D) volumes and not just in 2-dimensions. The texture calculations in the method of segmentation may be performed as a preprocessing step, and/or “on the fly”, at specific sub regions, in order to increase accuracy and improve quality of the resulting image. The region growing determination in the method of segmentation is based on texture images and texture calculations, which may altogether result in an improved and enhanced image quality. The method of segmentation may be used for identifying voxels of tissue, organs and other structures and increasing their value in images produced by medical imagers. For example, the method of segmentation may be used for identifying blood voxels and increasing their value in CT images. The method of segmentation may be divided into three major steps: The first step is preprocessing by an algorithm (Hybrid Edge Preserving Algorithm (HEPA)) that is used as an edge-preserving filter that may be applied to smooth an image without degrading its edges. The second step may include a creation of J texture from the CT images. The J texture may be calculated/created by calculating the variability values of a quantized image. The creation of the quantized image may be specifically adapted to CT images and may further be specifically adapted for various tissues, such as, for example, blood vessels, such as arteries. The third step is the application of a region growing process, based on the calculated texture. The region growing process may be designed to use texture and grow while remaining as a homogenous texture. The region growing process may also incorporate geometrical measures, such as, for example, a geometrical tubular measure, which may assure that the growing will occur only within blood vessels, which are of tubular structure.

According to some embodiments, there is provided a method of medical imaging of a structure that includes creating a three dimensional image of the structure and processing the image to enhance image quality such that images with an attenuation value below a threshold value result in a recognizable image, thereby identifying the structure. Creating the three dimensional image of the structure may include creating a three dimensional texture image data of the structure. Creating the three dimensional texture image data may include using a J-value texture process, Gabor filter, Markov Random Field (MRF), Grey Level Co-occurrence Matrix (GL-CM), or any combination thereof. The method may further include processing by an edge-preserving filter that is adapted to smooth the image while essentially maintaining edges of the image. The processing by the edge- preserving filter may be performed prior to creating a three dimensional texture image data. The edge-preserving filter may include a Hybrid edge preserving algorithm (HEPA) filter, which may include at least one algorithm from a peer group filter and/or a bilateral filter.

According to further embodiments the creation of the three dimensional texture image data may be applied for at least a sub region of a volume data.

According to other embodiments, the method of medical imaging of a structure may further include performing a region-growing algorithm on the three dimensional texture image data, wherein the region-growing algorithm is adapted to grow the image while essentially remaining in a homogenous texture. The region-growing algorithm may incorporate a geometrical tubular measure, which is adapted to facilitate image growing substantially within tubular structures.

According to other embodiments, the method of medical imaging of a structure may further include performing a differential geometry algorithm on the three dimensional texture image data, wherein the differential geometry algorithm is adapted to grow the image while essentially remaining in a homogenous texture. The differential geometry algorithm incorporates a geometrical tubular measure, which is adapted to facilitate image growing substantially within tubular structures.

According to additional embodiments, the structure may include a blood vessel. The structure may further include a body, body part, organ, tissue, cell, arrangement of tissues, arrangement of cells, or any combination thereof.

According to some embodiments, the three dimensional image data may include a three dimensional volume data set, form of digital data, location of pixels, coordinates of pixels, distribution of pixels, intensity of pixels, vectors of pixels, location of voxels, coordinates of voxels, distribution of voxels, intensity of voxels, or any combination thereof.

According to some embodiments, the medical imaging may include Computerized Tomography (CT). The medical imaging may include Magnetic Resonance Imaging (MRI). The medical imaging may further include Ultrasound (US), Computerized Tomography Angiography (CTA), Magnetic Resonance Angiography (MRA), Positron Emission Tomography (PET), PET/CT, 2D-Angiography, 3D-Angiography, X-ray/MRI, or any combination thereof.

According to some embodiments, the attenuation value in the method of medical imaging of a structure may be measured in Hounsfield units (HU). The threshold value in the method may be lower than about 200 HU.

According to some embodiments, the method of medical imaging may further include administration of contrast material. The contrast material may include Iodine, radioactive isotope of Iodine, Gadolinium, micro-bubbles agent, or any combination thereof. The contrast material may further include molecular imaging contrast material, which may include Glucose enhanced with iodine, liposomal iodixanol, technetium, deoxyglucose, or any combination thereof.

According to some embodiments, there is provided a device for medical imaging of a structure that includes an image processing module adapted to create a three dimensional image of a structure within the living tissue and to use image data correlated to the structure to enhance image quality such that an image with an attenuation value below a threshold value results in a recognizable image. The three dimensional image of a structure may include a three dimensional texture image data of a structure. The device may further include a J-value texture process, Gabor filter, Markov Random Field (MRF), Grey Level Co-occurrence Matrix (GL-CM), or any combination thereof, adapted to create a three dimensional texture image data. The device may further include an edge-preserving filter adapted to smooth the image while essentially maintaining edges of the image. The edge-preserving filter may be adapted to perform processing prior to the creation of the three dimensional texture image data. The edge-preserving filter may include a Hybrid edge preserving algorithm (HEPA) filter, which may include at least one algorithm from a peer group filter and/or a bilateral filter.

According to further embodiments, the creation of a three dimensional texture image data may be applied for at least a sub region of a volume data. The device may further include a region-growing algorithm adapted to be performed on the three dimensional texture image data. The region-growing algorithm may be adapted to grow the image while essentially remaining in a homogenous texture. The region-growing algorithm may incorporate a geometrical tubular measure, which may be adapted to facilitate image growing substantially within tubular structures. According to additional embodiments, the device may further include a differential geometry algorithm adapted to be performed on the three dimensional texture image data. The differential geometry algorithm may be adapted to grow the image while essentially remaining in a homogenous texture. The differential geometry algorithm may incorporate a geometrical tubular measure, which may be adapted to facilitate image growing substantially within tubular structures.

According to additional embodiments, the structure imaged by the device may include a blood vessel. The structure may further include a body, body part, organ, tissue, cell, arrangement of tissues, arrangement of cells, or any combination thereof.

According to further embodiments, the three dimensional image data created by the device may include: a three dimensional volume data set, form of digital data, location of pixels, coordinates of pixels, distribution of pixels, intensity of pixels, vectors of pixels, location of voxels, coordinates of voxels, distribution of voxels, intensity of voxels, or any combination thereof.

According to some embodiments, the medical imaging may include a Computerized Tomography (CT). The medical imaging may include a Magnetic Resonance Imaging (MRI). The medical imaging may include Ultrasound (US), Computerized Tomography Angiography (CTA), Magnetic Resonance Angiography (MRA), Positron Emission Tomography (PET), PET/CT, 2D-Angiography, 3D-Angiography, X-ray/MRI, or any combination thereof.

According to some embodiments, the attenuation value of the image may be measured in Hounsfield units (HU). The threshold value is lower than about 200 HU.

According to additional embodiments, administration of contrast material may also be performed. The contrast material may include: Iodine, radioactive isotope of Iodine, Gadolinium, micro-bubbles agent, or any combination thereof. The contrast material may further include molecular imaging contrast material. The molecular imaging contrast material comprises Glucose enhanced with iodine, liposomal iodixanol, technetium, deoxyglucose, or any combination thereof.

According to some embodiments, there is provided a system for medical imaging that includes a scanning portion adapted to scan a living tissue and an image processing module adapted to create a three dimensional image of a structure within the living tissue and to use image data correlated to the structure to enhance image quality such that an image with an attenuation value below a threshold value results in a recognizable image. The three dimensional image of a structure may include a three dimensional texture image data of a structure. The system may further include a J-value texture process, Gabor filter, Markov Random Field (MRF), Grey Level Co-occurrence Matrix (GL-CM), or any combination thereof, adapted to create a three dimensional texture image data. The system may further include an edge-preserving filter adapted to smooth the image while essentially maintaining edges of the image. The edge-preserving filter may be adapted to perform processing prior to the creation of the three dimensional texture image data. The edge-preserving filter may include a Hybrid edge preserving algorithm (HEPA) filter, which may include at least one algorithm from a peer group filter and/or a bilateral filter.

According to further embodiments, the creation of a three dimensional texture image data may be applied for at least a sub region of a volume data. The system may further include a region-growing algorithm adapted to be performed on the three dimensional texture image data. The region-growing algorithm may be adapted to grow the image while essentially remaining in a homogenous texture. The region-growing algorithm may incorporate a geometrical tubular measure, which may be adapted to facilitate image growing substantially within tubular structures. According to additional embodiments, the system may further include a differential geometry algorithm adapted to be performed on the three dimensional texture image data. The differential geometry algorithm may be adapted to grow the image while essentially remaining in a homogenous texture. The differential geometry algorithm may incorporate a geometrical tubular measure, which may be adapted to facilitate image growing substantially within tubular structures.

According to additional embodiments, the structure imaged by the system may include a blood vessel. The structure may further include a body, body part, organ, tissue, cell, arrangement of tissues, arrangement of cells, or any combination thereof.

According to further embodiments, the three dimensional image data created by the system may include: a three dimensional volume data set, form of digital data, location of pixels, coordinates of pixels, distribution of pixels, intensity of pixels, vectors of pixels, location of voxels, coordinates of voxels, distribution of voxels, intensity of voxels, or any combination thereof.

According to some embodiments, the system may include a Computerized Tomography (CT). The system may include a Magnetic Resonance Imaging (MRI). The system may include Ultrasound (US), Computerized Tomography Angiography (CTA), Magnetic Resonance Angiography (MRA), Positron Emission Tomography (PET), PET/CT, 2D-Angiography, 3D-Angiography, X-ray/MRI, or any combination thereof.

According to additional embodiments, the system may further include administration of contrast material. The contrast material may include: Iodine, radioactive isotope of Iodine, Gadolinium, micro-bubbles agent, or any combination thereof. The contrast material may further include molecular imaging contrast material. The molecular imaging contrast material comprises Glucose enhanced with iodine, liposomal iodixanol, technetium, deoxyglucose, or any combination thereof.

### BRIEF DESCRIPTION OF FIGURES

Examples illustrative of embodiments of the disclosure are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIGS. 1-1A schematically illustrate an exemplary image processing device and system, in accordance with an embodiment of the disclosure;

FIG. 2 schematically illustrates a depiction of a series of images in accordance with an embodiment of the disclosure;

FIG. 3 schematically illustrates an exemplary vessel segmented from surrounding structures, in accordance with an embodiment of the disclosure;

FIGS. 4A-4J illustrate a flow diagram of a method of imaging in accordance with several embodiments of the disclosure;

FIGS. 5A-5D illustrate a flow diagram of a method of segmentation, in accordance with an embodiment of the disclosure; and

FIG. 6 illustrates a flow diagram of a method of segmentation, in accordance with another embodiment of the disclosure.

### DETAILED DESCRIPTION

Unless specifically stated otherwise, as apparent from the following discussions, it is appreciated that throughout the specification, discussions utilizing terms such as “selecting,” “processing,” “computing,” “calculating,” “determining,” or the like, may refer to the actions and/or processes of a computer, computer processor or computing system, or similar electronic computing device, that may manipulate and/or transform data represented as physical, such as electronic, quantities within the computing system's registers and/or memories into other data similarly represented as physical quantities within the computing system's memories, registers or other such information storage, transmission or display devices. In some embodiments processing, computing, calculating, determining, and other data manipulations may be performed by one or more processors that may, in some embodiments, be linked.

In some embodiments, the term “essentially free of contrast material” or “not highlighted by contrast material” may, in addition to the regular understanding of such term, mean having contrast material in quantities that are insufficient to provide a clear or visibly distinct definition of the boundaries of the lumen of a vessel wherein such contrast material may be found. In some embodiments, the term “essentially free of contrast material” may mean that a contrast material was not administered. According to some embodiments, the term “essentially free of contrast material” may also mean no contrast material, lower amounts than normal of contrast material, lower concentration than normal of contrast material, a mixture of varying amounts of various contrast materials, trace amounts of contrast material and/or various kinds of contrast materials that may be different than the regularly used contrast material.

As referred to herein, the terms “image processing device”, “image processor”, “image processing device and system”, “data processing unit”, and/or “image processing module” may interchangeably be used.

As referred to herein, the terms “diagnostic imager”, “diagnostic imaging device”, “diagnostic scanner”, “scanner”, and/or “scanning portion” may interchangeably be used.

As referred to herein, the term “image” may also include part of an image, section of an image, pattern displayed in an image, and/or structure displayed in an image.

As referred to herein, “enhancing an image” and “enhancing image quality”, may include improving an image resolution, improving image intensity, improving image contrast, improving attenuation of an image, improving distinguishing of and between details in an image, increasing clarity in an image, increasing discernment in an image, increasing the ability to detect and/or define recognizable patterns in an image, and/or increasing the ability to detect and/or define recognizable structures in an image. According to some embodiments, enhancing an image quality may result in increasing diagnostic and/or clinical value of the image.

As referred to herein, the terms “attenuation”, “attenuation value”, “pixel value(s)”, “intensity”, and/or “intensity value”, may be interchangeably be used. According to some embodiments, attenuation, attenuation value, pixel value(s), intensity and intensity value may be measured by Hounsfield Units (HU).

As referred to herein, the terms “otherwise poorly recognizable images” and “images that were otherwise poorly recognizable”, may include images or parts of images whose details are not clear, distinguishable, distinct, resolved or any combination thereof. The terms “otherwise poorly recognizable images” and “images that were otherwise poorly recognizable”, may further include images or parts of images, that include patterns, structures, and the like which are not clear, distinguishable, distinct, resolved or any combination thereof. The terms “otherwise poorly recognizable images” and “images that were otherwise poorly recognizable”, may further include no recognizable images or parts of images. The terms “otherwise poorly recognizable images” and “images that were otherwise poorly recognizable”, may further include images or parts of images with non-recognizable patterns, structures, and the like.

According to some embodiments, the term “frame” may include an image or any portion of an image. The term “frame” may further include a single image or portion of an image in a series of consecutive images or portion of images. A “frame segment” may include any portion of a frame. A frame may be acquired, by, for example, but not limited to, a sensor, a sensor array and the like.

According to some embodiments, the term “structure” may include any body or any part of a body. The term “structure” may further include any internal or external body parts, such as, for example; but not limited to, limbs, tissues, organs, cells, and the like. The term “structure” may further include any arrangement or formation of tissues, organs, or other parts of an organism, such as for example, but not limited to blood vessels.

The processes and functions presented herein are not inherently related to any particular computer, imager, network or other apparatus. Embodiments described herein are not described with reference to any particular programming language, machine code, and so forth. It will be appreciated that a variety of programming languages, network systems, protocols or hardware configurations may be used to implement the teachings of the embodiments of the disclosure as described herein.

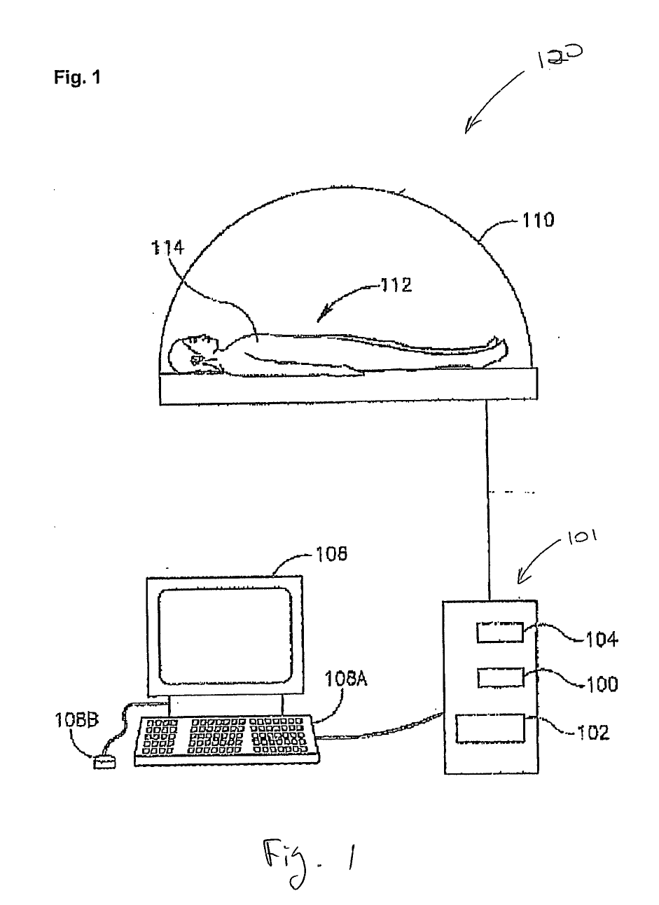

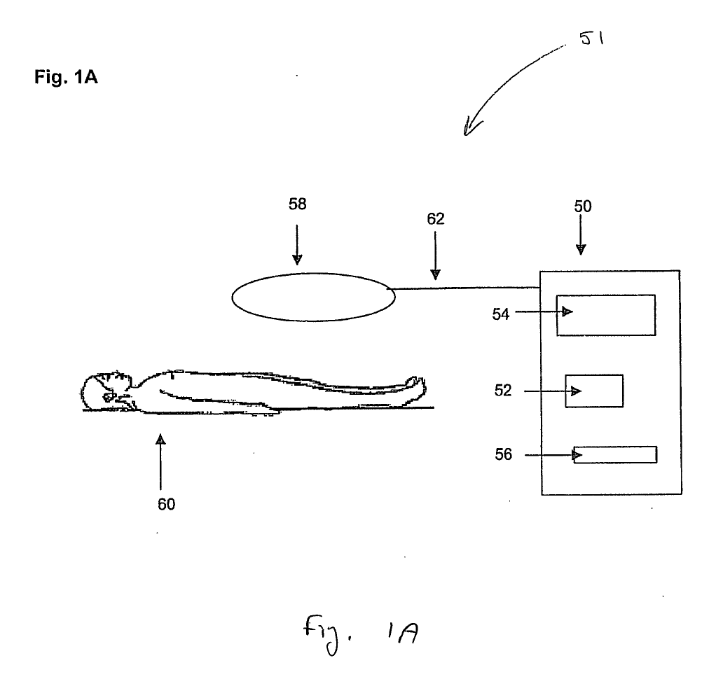

Reference is made to FIG. 1, which schematically illustrates an exemplary image processing device 101 and system 120, in accordance with an embodiment of the disclosure. Image processing device 101, in accordance with an embodiment of the disclosure, may include a processor 100 such as, for example, a central processing unit (CPU), which may also be or include a digital signal processing (DSP) device. Image processing device 101 may include or be connected to a memory unit (MU) 102 such as a hard drive, random access memory, read only memory or other mass data storage unit. In some embodiments, image processing device 101 may include or be connected to a magnetic disk drive (DD) 104 such as may be used with a floppy disc, disc on key or other storage device. In some embodiments of the disclosure, any one of the CPU, MU and/or DD may be externally located to image processing device 101. Image processing device 101 may include or be connected to one or more displays 106 and to an input device 108 such as, for example, a key board 108A, a mouse, or other pointing device 108B or input device by which, for example, a user may indicate to a processor 100 a selection or area that may be shown on a display. In some embodiments, processor 100 may be adapted to execute a computer program or other instructions so as to perform a method in accordance with embodiments of the disclosure. In some embodiments of the disclosure, image processing device 101 may comprise hardware, including associated filtering and/or compression circuitry, adapted to perform the method in accordance with embodiments of the disclosure.

Image processing device 101 may be connected to an external or ex vivo diagnostic imager 110, such as, for example, a computerized tomography (CT) device, magnetic resonance (R) device, ultrasound scanner, CT Angiography, magnetic resonance angiograph, positron emission tomography or other imagers 110. In some embodiments, imager 110 may capture one or more images of a body 112 or body part such as for example a blood vessel 114, a tree of blood vessels, alimentary canal, urinary tract, reproductive tract, or other tubular vessels or receptacles. In some embodiments, imager 110 or image processor 101 may combine one or more images or series of images to create a 3D image, which may also be referred to hereinafter as volume data, of an area of interest of a body or body part such as, for example, a blood vessel 114. In some embodiments, a body part may include a urinary tract, a reproductive tract, a bile duct, nerve or other tubular part or organ that may, for example, normally be filled or contain a body fluid. In some embodiments, imager 110 and/or image processor 101 may be connected to a display 106 such as a monitor, screen, or projector upon which one or more images may be displayed or viewed by a user.

According to further embodiments, and as described by way of example in FIG. 1A, there is provided an image processing device 50 and system 51. The image processing device 50 may include at least one processor 52, one or more displays 54 and at least one input device 56, that may form an integral, independent unit. The image processing device 50 may be adapted to execute a computer program and/or algorithm and/or other instructions so as to perform a method in accordance with some embodiments. The image processing device may optionally be adapted to use any hardware and/or firmware required to perform the method, including associated filtering and/or compression circuitry. The image processing device may be further connected physically and/or functionally to a diagnostic imager, such as diagnostic imager 58 in FIG. 1A. The diagnostic imager may include an external diagnostic imager, an ex vivo diagnostic imager, or an internal diagnostic imager. An internal diagnostic imager may include, for example, an imager which may include an internal source and an external scanner and/or an imager which includes an internal source and internal scanner. The connection between image processing device 50 and diagnostic imager 58 may be permanent, so that the image processing device and the diagnostic imager form one integral unit; the connection between the image processing device and the diagnostic imager may be transient. The connection between image processing device 50 and diagnostic imager 58 may be achieved by various ways, such as for example, by direct interaction; by mediators such as by use of wires, cables (such as for example, mediator 62 in FIG. 1A) and the like; indirectly, such as for example by use of any form removable/portable storage media; by wireless means, such as for example by wireless communication route; or any combination thereof. The connection between image processing device 50 and diagnostic imager 58 may be used for the transfer of various kinds of information between the devices. Transfer of various kinds of information between the devices by any connection route mentioned above herein may be performed instantaneously, in real time, or may be performed in delay. Likewise, operations performed by image processing device 50 on, for example, information transferred from diagnostic imager 58, may be performed instantaneously in real time; may be performed in a delay that may be a short delay, such as for example in the range of 1-60 minutes, or in longer delay times, such as for example in the range of more than 60 minutes and; may be performed off line, wherein diagnostic imager 58 is not necessarily in operative mode. Determination of the occasion at which operations are to be performed by image processing device 50 on, for example, information transferred from diagnostic imager 58, may be done by a user of the image processor device and/or the diagnostic imager.

According to some embodiments, diagnostic imager 58 that may be connected to image processing device 50 may include various kinds of diagnostic imagers, such as, for example, but not limited to, Computerized Tomography (CT) device, Magnetic Resonance (MR) device, Ultrasound (US) Scanner, Computerized Tomography Angiography (CTA), Magnetic Resonance Angiography (MRA), Positron Emission Tomography (PET), PET/CT, 2D-Angiography, 3D-angiography, X-ray/MRI devices, and the like. Diagnostic imager 58 may be used to obtain and/or capture one or more images of, for example, a subject body 60 that may include, for example: part of a body, such as a limb; organ(s), such as internal organs, paired organs, symmetric organs; tissue(s), such as a soft tissue, hard tissue; cells; body vessels, such as blood vessel, a tree of blood vessels, alimentary canal, urinary tract, reproductive tract, tubular vessels, receptacles and the like, and any combination thereof. Image processor 50 may combine, in accordance with some embodiments, one or more images or series of images obtained by diagnostic imager 58 to create 2D and/or 3D images of an area of interest of a subject body, as detailed above herein. Images thus obtained may be displayed upon the at least one display, for example display 54, of image processing device 50, or may be transferred to a remote location to be displayed at the remote location. Transferring information to a remote location may include any way of transferring information, such as, for example, disk on key, portable hard drive, disk, or any other applicable storage device, as well as wired and/or wireless communication route. The images may be viewed and optionally further analyzed by a user, such as, for example, a health care provider (that may include, among others, health care professionals such as a physician, nurse, health care technician, and the like), at any time point after obtaining the images and at any location that harbors the appropriate means to display and (optionally) analyze the images.

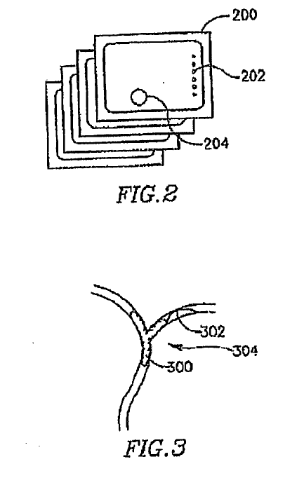

Reference is made to FIG. 2, which schematically illustrates a depiction of a series of images in accordance with an embodiment of the disclosure. In some embodiments, a series of images 200 may be arranged, for example in an order that may, when such images 200 are stacked, joined or fused by for example a processor, create a three dimensional view of a body part such as a blood vessel 114, or provide volume data on a body part or structure. In some embodiments, images 200 in a series of images may be numbered sequentially or otherwise ordered in a defined sequence. In some embodiments, images 200 may include an arrangement, matrix or collection of voxels 202, or optionally pixels or other atomistic units that may, when combined, create an image. In some embodiments, voxels 202 may exhibit, characterize, display or manifest an image intensity of the body part appearing in the area of image 200, corresponding to voxel 202. In some embodiments, an image intensity of voxel 202, may be measured in Hounsfield units (HU) or in other units.

In some embodiments, a location of voxel 202 in image 200 may be expressed as a function of coordinates of the position of the voxel on a three dimensional (3D) xyz plane. Optionally, a location of a pixel may be expressed as a function of its coordinates on a two dimensional (2D) xy plane. Other expressions of location, intensity and characteristics may be used.

In some embodiments, a user of an image processing device or system, such as that shown in FIG. 1 at 101 and 120, respectively, or optionally in FIG. 1A at 50 and 51, respectively, may view image 200 on, for example display 106, and may point to or otherwise designate an area of image 200 as for example an object 204. In some embodiments, object 204 may be or include a location within image 200 of a body part such as for example vessel 114 or other structure or organ in a body. In some embodiments, object 204 may include one or more voxels 202 and a description of, or data about, a body part or organ that may appear in images 200, such as the image intensity of voxel 202 in object 204.

Reference is made to FIG. 3, which schematically illustrates an exemplary vessel 304 segmented from surrounding structures, in accordance with an embodiment of the disclosure. In some embodiments of the disclosure, a contrast material 300, such as for example, UltaVist 370 mg % Iodine or other suitable contrast materials as may be used for highlighting vessels, may be administered by way of ingestion, injection or otherwise into a body part such as vessel 304. In some embodiments, a calcified substance on an area of a vessel or vessel wall may be highlighted in an image. Contrast material 300 may highlight vessel 304 as vessel 304 appears in images 200 shown in FIG. 2. In some embodiments, no contrast material 300 may be introduced into the vessel. In some embodiments, a lesion, atheromatous, plaque or thrombi or other material that may for example adhere to, or be part of, the wall of vessel 304 or to a wall of an organ of vessel 304, may create a blockage 302 of vessel 304, and may stop, limit or impair contrast material 300 from reaching a part of vessel 304, such as a part of vessel 304 that is anatomically or circulatorally distal from the point of introduction of contrast material 300 to vessel 304.

According to some embodiments, contrast material, such as contrast material 300, may be used for highlighting subject body or at least part of a body, such as for example a limb; organ(s), such as internal organs, paired organs, symmetrical organs, individual organs; tissue(s), such as a soft tissue, hard tissue; cells; body vessels, such as blood vessel, a tree of blood vessels, alimentary canal, urinary tract, reproductive tract, tubular vessels, receptacles and the like, or any combination thereof. Contrast material 300 may include any suitable contrast material or a combination of contrast material with other substances and agents such as, for example, additional contrast material, carriers, buffers, saline, diluents, solvents, body fluids and the like. Suitable contrast materials may include such materials as, but not limited to: Iodine, isotopic forms of Iodine, such as radioactive Iodine, Gadolinium, Gadolinium Chelates, micro-bubbles agent, molecular imaging contrast agent (such as detailed below herein), or any other suitable material that may be used as contrast material, or any combination thereof. Contrast material 300 may be administered to the subject body, or part of a body, as detailed above herein, by various ways, such as, for example, by inhalation, by ingestion, by injection, by rectal insertion or any other appropriate route of administration and any combination thereof. Contrast material 300 may be secludedly administered. Contrast material 300 may be administered, for example, in the form of a bolus wherein the contrast material may be mixed, prior to administration with a fluid. For example, the bolus may include contrast material 300 and saline. In addition, after administration of the bolus, a saline push may be administrated. Saline push may include an additional administration of saline, (for example, in a volume of 20-50 ml) that may be administered in a short time (such as between I to 60 seconds) after administration of the bolus containing contrast material 300. Administration of contrast material 300 to the subject may allow a spatial and/or temporal tracing of the contrast material in the subject, which may be used in a method according to some embodiments. Tracing the contrast material may be performed at various spatial (locations/regions) and temporal (time points) distributions. For example, tracing contrast material may be performed in a region that is located at a spatial and/or temporal region that is before the bolus. This may mean that the bolus has not yet reached the location of the tracing region. For example, tracing contrast material may be performed in a region that is located at a spatial and/or temporal region that is correlated with the location of the bolus. For example, tracing contrast material may be performed in a region that is located at a spatial and/or temporal region that is after the bolus. This may mean that the bolus has already reached and passed the location of the tracing region. Tracing contrast material may include tracing a high amount/concentration of contrast material 300. High amount/concentration of contrast material 300 may include for example, about 75%-100% of the amount of contrast material administered. Tracing the contrast material may include tracing an average amount/concentration of contrast material 300. Average amount/concentration of contrast material 300 may include, for example, about 50%-75% of the amount of contrast material administered. Tracing the contrast material may include tracing a low amount/concentration of contrast material 300. Low amount/concentration of contrast material 300 may include, for example, about 25%-50% of the amount of contrast material administered. Tracing the contrast material may include tracing a trace amount/concentration of contrast material 300. Trace amount/concentration of contrast material 300 may include, for example, about 0.000001%-25% of the amount of contrast material administered. Furthermore, trace amounts may include about 0.000001%-15% of the amount of contrast material 300 administered. Furthermore, trace amounts may include about 0.000001%-10% of the amount of the contrast material administered. Furthermore, trace amounts may include about 0.000001%-5% of the amount of the contrast material administered. Furthermore, trace amounts may include about 0.000001%-2.5% of the amount of the contrast material administered. Furthermore, trace amounts may include about 0.000001%-1% of the amount of the contrast material administered. Furthermore, trace amounts may include about 0.000001%-0.05% of the amount of the contrast material administered. Furthermore, trace amounts may include about 0.000001%-0.01% of the amount of the contrast material administered. Furthermore, trace amounts may include about 0.000001%-0.005% of the amount of the contrast material administered. Furthermore, trace amounts may include about 0.000001%-0.0005% of the amount of the contrast material administered. Tracing the contrast material may further include tracing absence of contrast material (0%).

According to some embodiments, the contrast material administered to a subject, such as for example in the form of a bolus, may include a lower percentage of contrast material 300 than is routinely used. For example, according to some embodiments, the bolus injected to a subject may include 0.1%-50% of contrast material 300. Furthermore, the contrast material administered to a subject, such as, for example, in the form of a bolus, may include 0.1%-40% of the contrast material. Furthermore, the contrast material administered to a subject, such as, for example, in the form of a bolus, may include 0.1%-25% of the contrast material. Furthermore, the contrast material administered to a subject, such as, for example, in the form of a bolus, may include 0.1%-10% of the contrast material. Furthermore, the contrast material administered to a subject, such as, for example, in the form of a bolus, may include 0.1%-5% of the contrast material. Furthermore, the contrast material administered to a subject, such as, for example, in the form of a bolus, may include 0.1%-2% of the contrast material.

According to some embodiments, the contrast material administered to a subject, such as for example in the form of a bolus, may include lower volume of contrast material 300. For example, volume of contrast material 300 that is routinely used, is at a range of about 80-150 ml. As a non-limiting example, Iodine containing contrast material, such as UltaVist (at a concentration of 370 mg/dl) may be used. As another, non-limiting example, Gadolinium containing contrast material may be used. According to some embodiments, volume of contrast material 300 that may be used in a method according to some embodiments may include about 0.1-60 ml. Furthermore, the volume of the contrast material at the above mentioned concentration that may be used in a method according to some embodiments may include about 0.1-40 ml. Furthermore, the volume of the contrast material at the above mentioned concentration that may be used in a method according to some embodiments may include about 0.1-20 ml. Furthermore, the volume of the contrast material at the above mentioned concentration that may be used in a method according to some embodiments may include about 0.1-10 ml. Furthermore, the volume of the contrast material at the above mentioned concentration that may be used in a method according to some embodiments may include about 0.1-5 ml. Furthermore, the volume of the contrast material at the above mentioned concentration that may be used in a method according to some embodiments may include about 0.1-2 ml.

According to some embodiments, the contrast material administered to a subject, such as, for example, in the form of a bolus, may include lower amounts of contrast material 300. For example, the amount of contrast material 300, such as UltaVist that is routinely used, is at a range of about 290-600 mg. According to some embodiments, the amount of contrast material 300 that may be used in a method according to some embodiments may include about 0.1-500 mg. According to some embodiments, the amount of the contrast material that may be used in a method according to some embodiments may include about 0.1-400 mg. Furthermore, the amount of the contrast material that may be used in a method according to some embodiments may include about 0.1-300 mg. Furthermore, the amount of the contrast material that may be used in a method according to some embodiments may include about 0.1-200 mg. Furthermore, the amount of the contrast material that may be used in a method according to some embodiments may include about 0.1-100 mg. Furthermore, the amount of the contrast material that may be used in a method according to some embodiments may include about 0.1-50 mg. Furthermore, the amount of the contrast material that may be used in a method according to some embodiments may include about 0.1-20 mg. Furthermore, the amount of the contrast material that may be used in a method according to some embodiments may include about 0.1-10 mg. Furthermore, the amount of the contrast material that may be used in a method according to some embodiments may include about 0.1-1 mg.

Reducing flow rate of contrast material 300 after administration may be used in a system and method according to some embodiments. Lowering flow rate of the contrast material after administration may be as a result of, for example, reduced heart output, reduced blood flow, reduced administration rate, and any combination thereof.

According to some embodiments, the contrast material administered to a subject, such as, for example in the form of a bolus, may include lower administration rate of contrast material 300. For example, administration rate, for example by injection, of contrast material 300, such as UltaVist that is routinely used, is at a range of about 2-5 ml/second. According to some embodiments, the administration rate of the contrast material that may be used in a method according to some embodiments may include an administration rate of about 0.05 ml-2 ml/sec. Furthermore, the administration rate of the contrast material that may be used in a method according to some embodiments may include an administration rate of about 0.05 ml-1.5 ml/sec. Furthermore, the administration rate of the contrast material that may be used in a method according to some embodiments may include an administration rate of about 0.05 ml-1 ml/sec. Furthermore, the administration rate of the contrast material that may be used in a method according to some embodiments may include an administration rate of about 0.05 ml-0.75 ml/sec. Furthermore, the administration rate of the contrast material that may be used in a method according to some embodiments may include an administration rate of about 0.05 ml-0.5 ml/sec. Furthermore, the administration rate of the contrast material that may be used in a method according to some embodiments may include an administration rate of about 0.05 ml-0.25 ml/sec. Furthermore, the administration rate of the contrast material that may be used in a method according to some embodiments may include an administration rate of about 0.05 ml-0.1 ml/sec.

According to some embodiments, contrast material 300 administered to a subject may include a Gadolinium containing a contrast material. Gadolinium may be regularly/routinely used in applications such as, for example, MRI, at a dosage of 0.1-0.3 mmole/kg. Thus, an average weight adult subject may be administered with (dependant on the subject's weight) about 20-40 ml of contrast material 300 containing Gadolinium. Usually, the Gadolinium containing a contrast material is not mixed or diluted with saline or other material, and it may be administered by any administration route. When administered by, for example, injection, injection rate may be 1-3 ml/sec and may be followed by a saline push of, for example, 20 ml. Gadolinium containing a contrast material is not routinely used for applications such as CT. When rarely used for such applications, the dosage used may be up to 4 times higher than that used for an application such as an MRI. However, high amounts of Gadolinium containing a contrast material may impose health hazards to subjects administered with the material by causing severe side effects. According to some embodiments, contrast material 300 containing Gadolinium may be used in applications such as a CT, in a method and system in accordance with some embodiments. The Gadolinium material used according to some embodiments may include Gadolinium containing a contrast material at a dosage of about 0.001-0.25 mmole/kg. Furthermore, Gadolinium containing contrast material may be used at a dosage of about 0.001-0.20 mmole/kg. Furthermore, Gadolinium a containing contrast material may be used at a dosage of about 0.001-0.15 mmole/kg. Furthermore, Gadolinium containing a contrast material may be used at a dosage of about 0.001-0.10 mmole/kg. Furthermore, Gadolinium containing a contrast material may be used at a dosage of about 0.001-0.05 mmole/kg. Furthermore, Gadolinium containing a contrast material may be used at a dosage of about 0.001-0.01 mmole/kg. The Gadolinium material used according to some embodiments may include administration of Gadolinium containing a contrast material at an administration rate of about 0.01-2.5 ml/sec. Furthermore, the Gadolinium material used according to some embodiments may include administration of Gadolinium containing a contrast material at an administration rate of about 0.01-2 ml/sec. Furthermore, the Gadolinium material used according to some embodiments may include administration of Gadolinium containing a contrast material at an administration rate of about 0.01-1.5 ml/sec. Furthermore, the Gadolinium material used according to some embodiments may include administration of Gadolinium containing a contrast material at an administration rate of about 0.01-1 ml/sec. Furthermore, the Gadolinium material used according to some embodiments may include administration of Gadolinium containing a contrast material at an administration rate of about 0.01-0.5 ml/sec. Furthermore, the Gadolinium material used according to some embodiments may include administration of Gadolinium containing a contrast material at an administration rate of about 0.01-0.2 ml/sec. Furthermore, the Gadolinium material used according to some embodiments may include administration of Gadolinium containing a contrast material at an administration rate of about 0.01-1 ml/sec.

Lowering the percentage and/or volume and/or amount and/or administration rate of contrast material 300 administered to a subject may lower the spatial and temporal detection levels of the contrast material and therefore to overcome this potential problem, enhancement and a method for enhancement of detection and tracing and/or accuracy of detection and tracing is provided, according to some embodiments.

According to some embodiments, the contrast material administered to a subject may include a molecular imaging contrast material. Molecular imaging differs from traditional imaging in that probes/markers known as biomarkers are used to help image specific targets or pathways. Biomarkers may chemically interact with their surroundings and, in turn, alter the image according to the molecular changes occurring within the area of interest. Some exemplary molecular imaging contrast material that may be used in various medical applications such as, for example, CT and MRI, may include, but are not limited to: Glucose enhanced with iodine, liposomal iodixanol (a liposome with iodine that can be used as Contrast Agent for CT), technetium, deoxyglucose, and the like, or any combination thereof. In general, such molecular imaging contrast materials usually have to be used in relatively large volume, or be scanned using a large amount of radiation, in order to emphasize the presence of contrast material in specific locations. However, using such molecular imaging contrast materials in accordance with embodiments described herein may allow smaller amounts of contrast and lower radiation dose to be practiced. The use of molecular imaging contrast material is different from other methods of imaging which primarily image differences in qualities, such as, for example, densities. The ability to image fine molecular changes, may be used in various medical application, including early detection and treatment of disease as well as for basic pharmaceutical development. Furthermore, molecular imaging allows for quantitative tests, which adds a level of objectivity to the study of these areas. The same methods employed on blood vessels could be reproduced to enhance specific organs other than arteries. Such contrast agent can be used for example for: 1. Identifying cell death—for example, in the case of a suspected heart attack (myocardial infarction) physicians need to confirm quickly whether an attack has indeed occurred and, if so, how many heart cells have died or are dying as a result. By taking advantage of the body's natural response to apoptosis (programmed cell death), molecular imaging may tell physicians if and where in the body cells are dying rapidly. When a cell is dying, it turns inside out, presenting an otherwise unexposed protein binding site. In response, the body produces a protein called annexin, which seeks out and connects to the binding site of these dying cells to “tag” them for destruction by the immune system. By creating a conjugate of annexin, attaching it to the imaging agent technetium and injecting it into patients, scientists may “seek and illuminate” dying cells. Using 3D imaging units, health care providers may then take an image of the “tagged” dying cells. This image may provide the health care provider with information that can be uses to make accurate, fairly rapid diagnoses and provide patients with more precise treatment 2. Finding targeted cells—In general, cancer cells exhibit an increase in metabolic activity in comparison with normal cells. This fact makes it possible to image cancer cells in vivo using deoxyglucose, a metabolic substance that is voraciously glycolized and trapped by targeted cancer cells. By labeling deoxyglucose with a radioactive agent and injecting the resulting molecular imaging agent into patients, health care providers may make nuclear images of a primary tumor as well as metastatic sites throughout the body. 3. Assessing the efficacy of therapy—the object of some therapies, such as, for example, those designed to treat cancer, is to kill specific types of cells in the body. The object of others, such as, for example, angiogenesis drugs, is to promote the growth of new blood vessels (and thus, healthy cells). Because molecular imaging may target and illuminate both cell death and cell growth, it may tell an health care provider whether specific therapies are having their desired effect; whether, for example, chemotherapy is effectively killing cancer cells or whether an angiogenesis drug is creating new blood vessel growth in a damaged heart. For example, when chemotherapy or radiotherapy are used to kill cancer cells, the process of apoptosis occurs. If therapy is effective, apoptosis can be demonstrated within 24-to-48 hours of the initiation of therapy. If therapy is not shown to be effective, health care providers can elect to change the patients' therapy regimens. This provides two significant benefits: It increases the likelihood of a successful outcome and eliminates the costs associated with using an ineffective therapy. 4. Delivering therapy to targeted cells: If therapy is proving to be effective, annexin may be further used as a delivery vehicle to further enhance cell death. This may be performed by adding a payload of radioactive toxin to annexin. When injected, the “loaded” annexin may deliver the toxic agent to the site of dying cancer cells to cause even more cells to die. This creates a cycle of cell death, because the more cells that die, the more toxin-loaded annexin will be attracted to the cancer site. This molecular chain of events may help accelerate the efficacy of therapy.

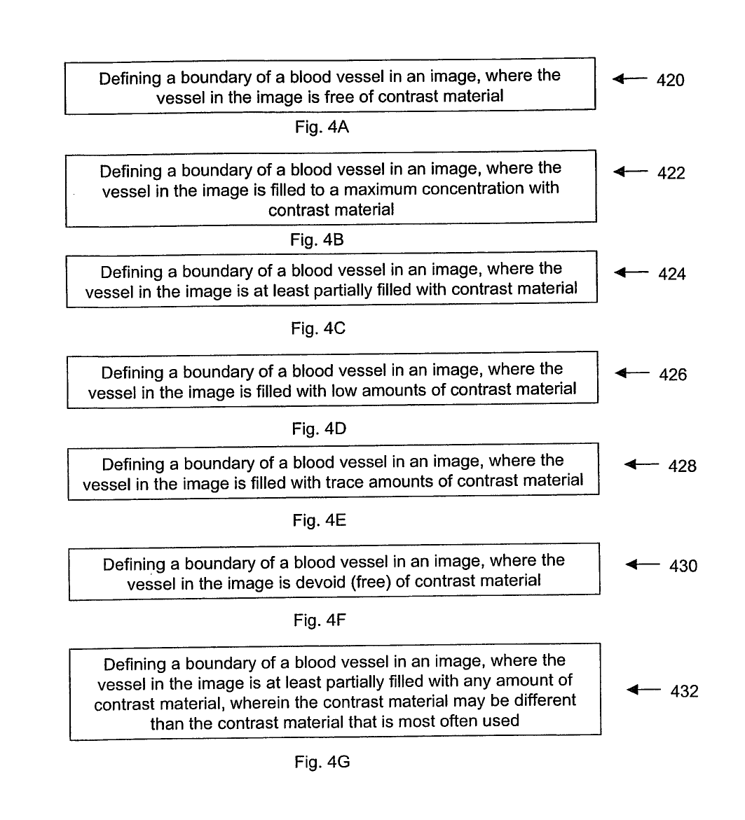

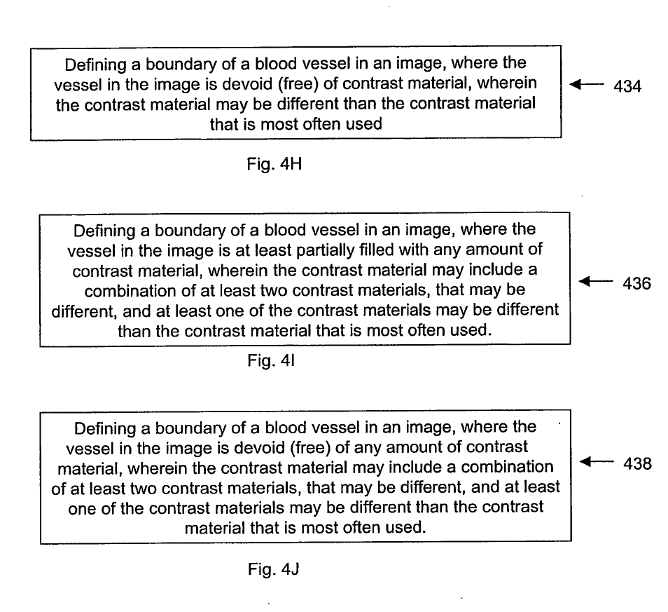

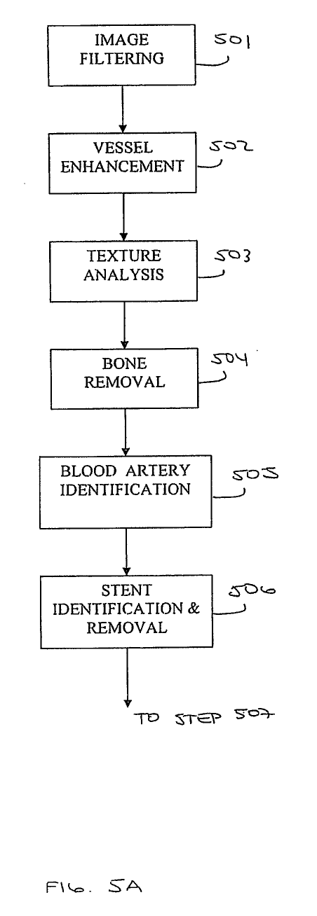

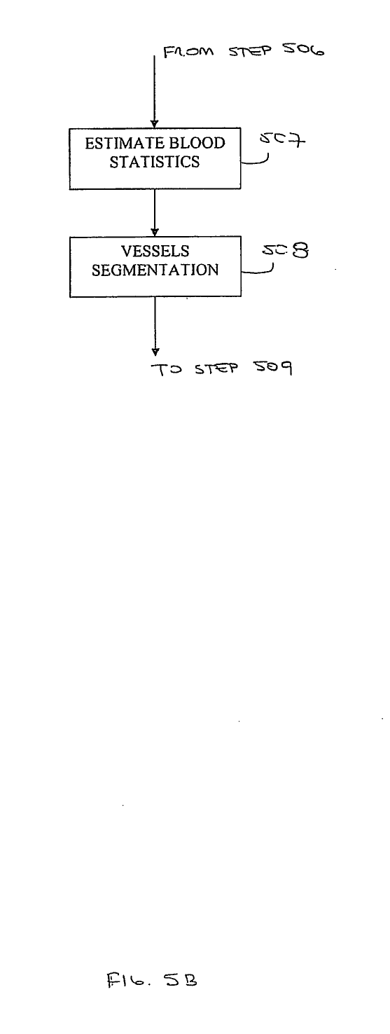

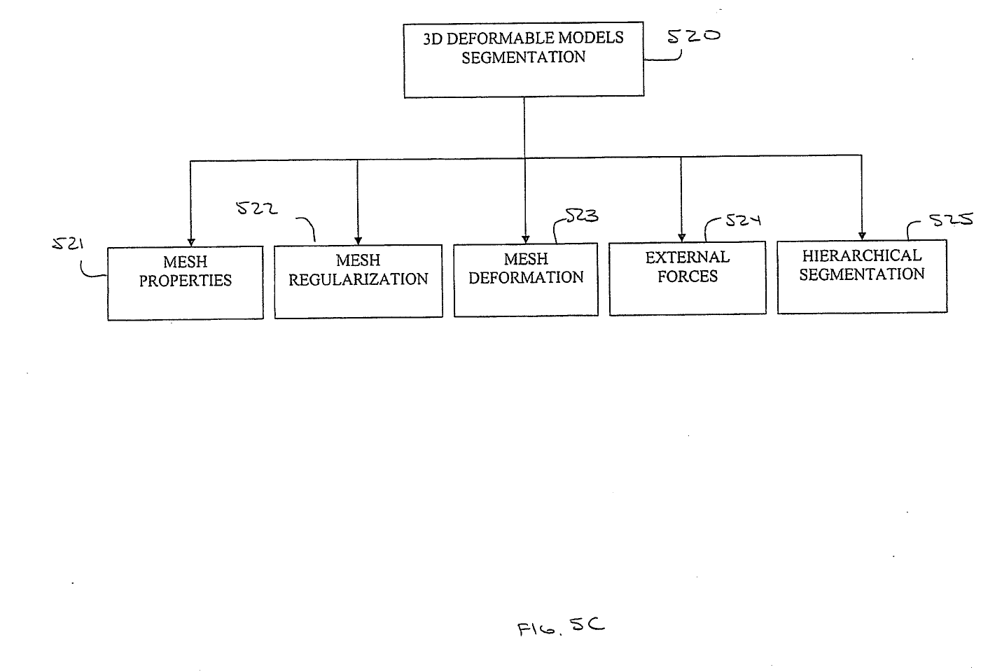

Reference is made to FIG. 4A, which illustrates a flow diagram of a method of imaging in accordance with an embodiment of the disclosure. In block 420, an image processor, which may be image processor 101 shown in FIG. 1, or optionally image processor 50 shown in FIG. 1A, may define a vessel, part of a vessel, boundary of a vessel, or any region of a vessel in an image or series of images, where the vessel in the image is not filled with contrast material. The image or series of images may be the same or substantially similar to images 200 shown in FIG. 2, and the vessel may be the same or substantially similar to vessel 300 shown in FIG. 3. In some embodiments, the image processor may segment, trace, define, display, differentiate, identify, measure, characterize, make visible or otherwise define the vessel or part of the vessel that contains only a small amount of contrast material or is free of or not highlighted by contrast material. In some embodiments, the image processor may display or define one or more boundaries, edges, walls or characteristics such as diameter, thickness of a wall, position, slope, angle, or other data of or about an organ or vessel when such vessel is free of or not highlighted by contrast material. Other boundaries or characteristics of the vessel may be displayed or defined in for example an image or in other collections of data about the vessel. In some embodiments, the image processor may define or display a boundary of the vessel and a boundary of a blockage of such vessel, such that a diameter of the vessel with the blockage and without the blockage may be displayed or calculated.

Reference is made to FIG. 4B which illustrates a flow diagram of a method of imaging in accordance with some embodiments of the disclosure. In block 422, an image processor, which may optionally be image processor 101 shown in FIG. 1, or optionally image processor 50 shown in FIG. 1A, may define a boundary of a vessel or part of a vessel in an image or series of images, where the vessel in the image is filled with material to a maximum concentration of contrast material. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that contains contrast material. According to some embodiments, the image processor may display or define one or more boundaries, edges, walls or characteristics such as diameter, thickness of a wall, position, slope, angle, or other data of or about an organ or vessel when such vessel is filled with contrast material. Other boundaries or characteristics of the vessel may be displayed or defined in, for example, the image or in other collections of data about the vessel. In some embodiments, the image processor may define or display the boundary of the vessel and a boundary of a blockage of such vessel, such that a diameter of the vessel with the blockage and without the blockage may be displayed or calculated.

Reference is made to FIG. 4C which illustrates a flow diagram of a method of imaging in accordance with some embodiments of the disclosure. In block 424, an image processor, which may optionally be image processor 101 shown in FIG. 1, or optionally image processor 50 shown in FIG. 1A, may define a boundary of a vessel or part of a vessel in an image or series of images, where the vessel in the image is at least partially filled with contrast material. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that at least partially contains contrast material. According to some embodiments, the image processor may display or define one or more boundaries, edges, walls or characteristics such as diameter, thickness of the wall, position, slope, angle, or other data of or about an organ or vessel when such vessel is at least partially filled with contrast material. Other boundaries or characteristics of the vessel may be displayed or defined in, for example, the image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4D which illustrates a flow diagram of a method of imaging in accordance with some embodiments of the disclosure. In block 426, an image processor, which may optionally be image processor 101 shown in FIG. 1, or optionally image processor 50 shown in FIG. 1A, may define a boundary of a vessel or part of a vessel in an image or series of images, where the vessel in the image is filled with low amounts of contrast material. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that contains low amounts of contrast material. According to some embodiments, the image processor may display or define one or more boundaries, edges, walls or characteristics such as diameter, thickness of the wall, position, slope, angle, or other data of or about an organ or vessel when such vessel is filled with low amounts of contrast material. Other boundaries or characteristics of the vessel may be displayed or defined in for example the image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4E which illustrates a flow diagram of a method of imaging in accordance with some embodiments of the disclosure. In block 428, an image processor, which may optionally be image processor 101 shown in FIG. 1, or optionally image processor 50 shown in FIG. 1A, may define a boundary of a vessel or part of a vessel in an image or series of images, where the vessel in the image is filled with only trace amounts of contrast material. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that contains only trace amounts of contrast material. According to some embodiments, the image processor may display or define one or more boundaries, edges, walls or characteristics such as diameter, thickness of the wall, position, slope, angle, or other data of or about an organ or vessel when such vessel is filled with only trace amounts of contrast material. Other boundaries or characteristics of the vessel may be displayed or defined in for example an image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4F which illustrates a flow diagram of a method of imaging in accordance with some embodiments of the disclosure. In block 430, an image processor, which may optionally be image processor 101 shown in FIG. 1, or optionally image processor 50 shown in FIG. 1A, may define a boundary of a vessel or part of a vessel in an image or series of images, where the vessel in the image is devoid (free) of contrast material. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that is devoid (free) of contrast material. According to some embodiments, the image processor may display or define one or more boundaries, edges, walls or characteristics such as diameter, thickness of the wall, position, slope, angle, or other data of or about an organ or vessel when such vessel is devoid (free) of contrast material. Other boundaries or characteristics of the vessel may be displayed or defined in for example the image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4G, which illustrates a flow diagram of a method of imaging in accordance with some embodiments of the disclosure. In block 432, an image processor, which may optionally be image processor 101 shown in FIG. 1, or optionally image processor 50 shown in FIG. 1A, may define a boundary of a vessel or part of a vessel in an image or series of images, where the vessel in the image is at least partially filled with any amount of contrast material, wherein the contrast material may be different than the contrast material that is most often used. For example, contrast material, such as Gadolinium that is usually used for applications such as an MRI, may be used, in accordance with some embodiments, in application such as a CT. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that is at least partially filled with any amount of contrast material, wherein the contrast material may be different than the contrast material that is most often used. According to some embodiments, the image processor may display or define one or more boundaries, edges, walls or characteristics such as diameter, thickness of the wall, position, slope, angle, or other data of or about an organ or vessel when such vessel is at least partially filled with any amount of contrast material, wherein the contrast material may be different than the contrast material that is most often used. Other boundaries or characteristics of the vessel may be displayed or defined in for example the image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4H, which illustrates a flow diagram of a method of imaging in accordance with some embodiments of the disclosure. In block 434, an image processor, which may optionally be image processor 101 shown in FIG. 1, or optionally image processor 50 shown in FIG. 1A, may define a boundary of a vessel or part of a vessel in an image or series of images, where the vessel in the image is devoid (free) of contrast material, wherein the contrast material may be different than the contrast material that is most often used. For example, contrast material, such as Gadolinium that is usually used for applications such as an MRI, may be used, in accordance with some embodiments, in application such as a CT. The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that is devoid (free) of contrast material, wherein the contrast material may be different than the contrast material that is most often used. According to some embodiments, the image processor may display or define one or more boundaries, edges, walls or characteristics such as diameter, thickness of the wall, position, slope, angle, or other data of or about an organ or vessel when such vessel is devoid (free) of contrast material, wherein the contrast material may be different than the contrast material that is most often used. Other boundaries or characteristics of the vessel may be displayed or defined in for example an image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4I which illustrates a flow diagram of a method of imaging in accordance with some embodiments of the disclosure. In block 436, an image processor, which may optionally be image processor 101 shown in FIG. 1, or optionally image processor 50 shown in FIG. 1A, may define a boundary of a vessel or part of a vessel in an image or series of images, where the vessel in the image is at least partially filled with any amount of contrast material, wherein the contrast material may include a combination of at least two contrast materials, that may be different, and at least one of the contrast materials may be different than the contrast material that is most often used. As a non-limiting example, the combination of contrast materials may include such materials as various forms of Iodine, Gadolinium, microbubble agent, and any appropriate contrast material. Such combination may be used, for example in applications such as an MRI (wherein Gadolinium is used more often) and/or a CT (wherein Gadolinium is used more rarely). The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that is at least partially filled with any amount of contrast material, at least partially filled with any amount of contrast material, wherein the contrast material may include the combination of at least two contrast materials, that may be different, and at least one of the contrast materials may be different than the contrast material that is most often used. According to some embodiments, an image processor may display or define one or more boundaries, edges, walls or characteristics such as diameter, thickness of the wall, position, slope, angle, or other data of or about an organ or vessel when such vessel is at least partially filled with any amount of contrast material, wherein the contrast material may include the combination of at least two contrast materials, that may be different, and at least one of the contrast materials may be different than the contrast material that is most often used. Other boundaries or characteristics of the vessel may be displayed or defined in, for example, an image or in other collections of data about the vessel. In some embodiments, the image processor may define or display the boundary of the vessel and the boundary of the blockage of such vessel, such that the diameter of the vessel with the blockage and without the blockage may be displayed or calculated.

Reference is made to FIG. 4J which illustrates a flow diagram of a method of imaging in accordance with some embodiments of the disclosure. In block 438, an image processor, which may optionally be image processor 101 shown in FIG. 1, or optionally image processor 50 shown in FIG. 1A, may define a boundary of a vessel or part of a vessel in an image or series of images, where the vessel in the image is devoid (free) of any amount of contrast material, wherein the contrast material may include a combination of at least two contrast materials, that may be different, and at least one of the contrast materials may be different than the contrast material that is most often used. As a non-limiting example, the combination of contrast materials may include such materials as various forms of Iodine, Gadolinium, microbubble agent, and any appropriate contrast material. Such combination may be used, for example in applications such as an MRI (wherein Gadolinium is used more often) and/or a CT (wherein Gadolinium is used more rarely). The image or series of images may optionally be the same or substantially similar to images 200 shown in FIG. 2, and the vessel may optionally be the same or substantially similar to vessel 300 shown in FIG. 3. The image processor may segment, trace, define, display, differentiate, identify, measure, characterize, make visible or otherwise define the vessel or part of the vessel that is devoid (free) of any amount of contrast material, at least partially filled with any amount of contrast material, wherein the contrast material may include the combination of at least two contrast materials, that may be different, and at least one of the contrast materials may be different than the contrast material that is most often used. According to some embodiments, the image processor may display or define one or more boundaries, edges, walls or characteristics such as diameter, thickness of the wall, position, slope, angle, or other data of or about an organ or vessel when such vessel is devoid (free) of any amount of contrast material, wherein the contrast material may include the combination of at least two contrast materials, that may be different, and at least one of the contrast materials may be different than the contrast material that is most often used. Other boundaries or characteristics of the vessel may be displayed or defined in, for example, the image or in other collections of data about the vessel. In some embodiments, the image processor may define or display the boundary of the vessel and the boundary of the blockage of such vessel, such that the diameter of the vessel with the blockage and without the blockage may be displayed or calculated.

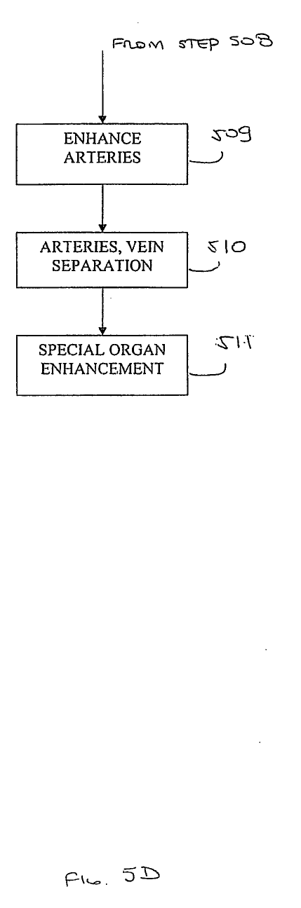

Reference is made to FIGS. 5A-5D which illustrate a flow diagram of a method of segmentation, in accordance with an embodiment of the disclosure. The method of segmentation may optionally be implemented as software or hardware, or any combination thereof, in image processing device 101 shown in FIG. 1, and/or optionally, in image processing device 50 shown in FIG. 2. Additionally, an image or series of images may be the same or substantially similar to images 200 shown in FIG. 2, and a vessel may be the same or substantially similar to vessel 300 shown in FIG. 3. The method of segmentation as detailed below herein may result in an improved, more accurate and enhanced image quality. For example, the method of segmentation may be specifically adapted to various imaging processes and imaging devices, such as for example, CT imager and CT images. Such specific adaptation may result in enhanced and more accurate image quality. The method of segmentation as described herein may operate and grow in 3-dimensional (3D) volumes and not just in 2-dimensions. The texture calculations in the method of segmentation may be performed as a preprocessing step, and/or “on the fly”, at specific sub regions, in order to increase accuracy and improve quality of the resulting image. The region growing determination in the method of segmentation is based on texture images and texture calculations, which may result in an improved and enhanced image quality.

The method of segmentation may be used for identifying voxels of tissue, organs and other structures and in increasing their value in images produced by medical imagers. For example, the method of segmentation may be used for identifying blood voxels and increasing their value in CT images. In general, the method of segmentation may be divided into three major steps: The first step is preprocessing by an algorithm (such as, for example, Hybrid Edge Preserving Algorithm (HEPA)) that may be used as an edge-preserving filter that may be applied to smooth an image without degrading its edges. The use of the HEPA filter may facilitate the creation of an optimal texture, and hence the creation of diagnostic imager images, such as, for example, CT images. The second step may include a creation of J texture from the acquired images (such as, for example the CT images). The J texture may be calculated/created by calculating the variability values of a quantized image. The creation of the quantized image may be specifically adapted to images obtained from various imaging devices (such as, for example, CT images and CT imager) and may further be specifically adapted for various tissues, such as, for example, blood vessels (such as arteries), and the like. By applying the first step of preprocessing using the HEPA filter, the quantized image may be enhanced and be more accurate. The texture may be calculated as a preprocess step for all 3D volume of images, or “on-the-fly”, in real time, at specific sub regions of the image. The third step is application of a region growing process, based on the calculated texture. The region growing process may be designed to use texture and grow while remaining in a homogenous texture. The region growing process may also incorporate geometrical measures that may be adapted to specifically determine the structures in which the growing process occurs. For example, the region growing process may incorporate a geometrical tubular measure, which assures that the growing will occur only within blood vessels (which are tubular structures).

The three steps of the method of segmentation are outlined as follows: the preprocessing stage shown in FIG. 5A; the segmentation stage shown in FIGS. 5B and 5C; and the post processing stage shown in FIG. 5D.

The preprocessing stage comprises the following steps: Image Filtering 501, Vessel Enhancement 502, Texture Analysis 503, Bone Removal 504, Blood Artery Identification 505, and Stent Identification and Removal 506.

[STEP 501] Image Filtering (Edge Preserving Filter):

In accordance with an embodiment of the disclosure, Image Filtering may be applied. This step is adapted to smooth the image while preserving the edges of the volume data, which may also be referred to as an “edge preserving filter”. Such step may comprise the use of a Hybrid Edge Preserving Algorithm (HEPA) filter that may be adapted to smooth the image while preserving the edges of the volume data and without further degrading the edges. The Filter may further enhance the true (“real”) edges without enhancing image noise. The HEPA filter examines neighbors of each voxel and classifies them into several classes (groups), such as, for examples, peers and non-peers. The filter uses a classifier that can reliably classify the voxels into the said groups. The smoothing is then performed by considering only the group members associated with the voxel being filtered—voxels belonging to the other groups are ignored (or used later on for edge enhancement). The said smoothing operation is performed by putting more weight on similar neighboring voxels and less weight on less similar neighboring voxels. The said similarity may be measured according to gray level values, color values, pixel values of several modalities, and the like, or any combination thereof. It is also possible to use the classification results for edge enhancements, making the edges between the different groups more easily apparent and distinct to the human eye. As the classification operation may be a time consuming operation, the HEPA filter may avoid the classification process if the entire neighborhood consists of similar voxels according to a simpler heuristic rule. In this case, all the neighboring voxels may be considered as belonging to the same group and participate in the filtering operation. The voxels may be classified, for example, by performing a Fisher linear discriminant analysis. Filtering is then performed by multiplying the voxel peers by a filtering kernel which filters the non-peers. An inner product of the voxel peers and the filtering kernel is calculated and used to replace the original voxel. The kernel filtering is determined by multiplying two Gaussian kernels; one kernel based on spatial distances of the neighbors from a central voxel, and the other kernel based on gray level distances between the neighbors and a central pixel.

In some embodiments of the disclosure, the HEPA filter may be made quicker by not calculating the Fisher discriminant. Classification of the voxels into peers and non-peers may not be required when an entire neighborhood consists of voxels with gray level values close to the central voxel value. Closeness measure may be based on heuristic noise level estimations for images from an external or ex vivo diagnostic imager, or optionally, by rough estimation of noise levels in the current image. Filtering is performed, considering all neighboring voxels are peers and are multiplied by the filtering kernel.

In some embodiments of the disclosure, if the volume of interest is blood volume and surrounding tissue, for example, as may be in a CT angiography, only voxels of a certain HU range may be considered as candidates for purposes of determining the Fisher discriminant. The remaining voxels may be filtered as their surrounding neighbors are classified as peers.

In some embodiments of the disclosure, Image Filtering comprises the use of a Peer Group (PG) filter and a Bilateral filter. The PG filter comprises a non-linear filter adapted to smooth the image, while preserving edges and removing impulse noise. With the PG filter each pixel is replaced with the weighted average of its peer group members, which are classified based on similarity with neighboring pixels. The Bilateral filter comprises a non-iterative filter adapted to smooth the image while preserving edges, using both domain and range neighborhoods. Pixels close to a pixel in the image domain and similar to a pixel in the image range are used to calculate the filter value. Two Gaussian kernels, one in the image domain and one in the image range, are used to smooth the image. This results in an image that is smoothed with preserved edges. Substantially any distance metric can be used for kernel smoothing the image range.

[STEP 502] Vessel Enhancement:

This step comprises a filter adapted to enhance 3D tubular structures in the volume data, such as, for example, blood vessels, urethra and intestines. In accordance with an embodiment of the disclosure, the second derivatives of a Gaussian kernel may be used to develop a Hessian matrix. Eigen values of the Hessian matrix are then analyzed to extract a direction of curvatures along the axis of the vessel.

[STEP 503] Texture Analysis (3D Texture Image Data):

In many CT images, different tissues or organs may not be differentiated based on their characteristic HU values, which may overlap significantly, but rather based on their textural qualities and features. A texture map may be calculated from the original CT image and then a segmentation algorithm may be deployed in order to classify this texture map into different tissue types.

In accordance with an embodiment of the disclosure, step 503 includes the creation of a 3D texture image date. This may be accomplished, for example, by using various methods for tissue classification and segmentation based on texture, such as, for example: J-value texture analysis, Gabor filter, Grey Level Co-occurrence Matrix (GL-CM), Markov Random Fields (MRF), or any combination thereof.

J-value texture (JT) analysis is performed to extract textural information from the volume data. In a first step, the number of gray values in the volume data is reduced through quantization. An example of a method of quantization may be that used by the JPEG (Joint Photographic Experts Group). This results in a map in which each pixel is represented by a class label. In a second step, J-value, which is the ratio of in-class variance to between class variance, is calculated for each voxel. J-values correspond to measurements of local homogeneities at different scales, which can indicate potential boundary locations. For example, for an image consisting of several homogeneous regions, the gray value classes are more separated from each other and the J-value is large. Additional information on JT segmentation algorithm, may be found in: “Unsupervised segmentation of color-texture regions in images and video”, Y. Deng and B. Manjunath, IEEE Transactions on Pattern Analysis and Machine Intelligence, Vol. 23, No. 8, pp. 800-810, 2001, incorporated herein by reference, in its entirety.

According to some embodiments, textural information may be extracted from texture measures based on the grey level co-occurrence matrix (GL-CM) as described in: “Textural Features for Image Classification”, Haralick, R. M., et. al., IEEE Transactions on Systems, Man and Cybernetics. SMC-3(6):610-620, 1973, Incorporated herein by reference, in its entirety; and “Statistical and Structural Approaches to Texture”, Haralick, R. M. Proceedings of the IEEE, 67:786-804, 1979, incorporated herein by reference, in its entirety.

In some embodiments of the disclosure, textural information may be extracted from the volume data by applying a bank of Gabor filters to the image. The resulting texture vectors may then be clustered. Additional information may be found in: “Comparison of texture features based on Gabor filters”, P. Kruizinga, N. Petkov and S. E. Grigorescu, Proceedings of the 10th International Conference on Image Analysis and Processing, Venice, Italy, Sep. 27-29, 1999, pp. 142-147, incorporated herein by reference, in its entirety.

In some embodiments of the disclosure, textural information may be extracted from the volume data by the use of Markov Random Fields (MRF). MRF comprises the use of probabilistic models that use a correlation between pixels in a neighborhood to decide an object region. The MRF may optionally use maximum a posteriori (MAP) estimates for modeling the MRF. The object traverses a data set and uses a model generated by a distance classifier, such as, for example, Mahalanobis distance classifier, to determine a distance between each pixel in the data set to a set of known classes. The distances may then be updated by evaluating the influence of neighboring pixels, and each pixel may be classified to the class which has the minimum distance to that pixel. Energy function minimization may be done, optionally using an iterated conditional modes (ICM) algorithm. Additional information may be found in: “Classification of textures using Gaussian Markov random fields”, Chellappa, R., et. al., IEEE Transactions on Signal Processing, Volume 33, Issue 4, August 1985 Page(s): 959-96, incorporated herein by reference, in its entirety.

[STEP 504] Bone Removal:

This step comprises bone removal from the volume data by using adaptive threshold segmentation based on prior knowledge and heuristics on bone properties such as location and distribution. The anatomical structure of bones may be used as they comprise a collection of pixels with high HU values with holes in them.

[STEP 505] Blood Artery Identification:

This step comprises searching for a blood artery in the volume data and identifying a point located inside the blood artery. An appropriate image slice is first found; for example, to identify the aorta in the volume data, a small number of bones, with only a vertebra bone present at that slice. Next, thresholds are applied to the image to identify circular shapes. For example, the aorta is identified by its size and location relative to the body and the vertebra.

[STEP 506] Stent Identification and Removal:

In this step, stents, if existing, are identified and removed from the volume data. The step comprises the use of adaptive threshold segmentation, along with heuristics, on such characteristics as location and shape, to extract the stents from the volume data. A Hough transform is used to identify circles, and an artery may be selected using details such as circle location, size, and HU value.

The segmentation stage includes segmentation of blood volume in the image, which may include arteries, and comprises the following steps: Estimate Blood Statistics 507, and Vessels Segmentation 508.

[STEP 507] Estimate Blood Statistics:

In this step, estimation of various tissue statistics, such as, for example, blood statistics may be performed. Estimation of blood statistics may be used to determine whether the segmentation is correct and is indeed performed on blood volume/blood vessels. Alternatively or in addition, Estimation of blood statistics may be used to determine whether the algorithm is growing in a correct direction. Blood statistics may include any type of parameter that is related to HU levels of blood vessels. For example, blood statistics may include such parameters and values as, but not limited to: mean, median, standard deviation, similarity, percentile, and the like, or any combination thereof. In order to determine blood statistics, various methods, either known in the art or to be developed in the future may be used and may include, for example, k-mean clustering, fuzzy logic, Gaussian Mixture Models (GMM), Hidden Markov Fields, Neural Networks, and the like, or any combination thereof. Another example that may be used for determination of blood statistics may include low scale segmentation of structure with the same J texture value around a point/region identified in an artery (from step 505). The resulting low-scale segmented volume can be used as a mask to extract HU values for statistics. For example, for a given subject, a pixel with a mean HU value of below a predetermined value (for example, H1) or above a predetermined value (for example, H2) may indicate that the structure examined is not a blood vessel. For example, H1 may be in the range of about 20 to 60; H2 may be in the range of about 280 to 320.

[STEP 508] Vessels Segmentation (Region Growing Algorithm):

In accordance with an embodiment of the disclosure, Vessels Segmentation may be performed using a region growing method, such as for example, 3D Deformable Models Segmentation 520, which is based on a deformable surface model using 3D surface meshes for surface representation. Deformable Models are a group of image segmentation techniques, that were created in order to deal with an image with no clear sharp edges (due to, for example, artifacts and noise, or even due to organs/tissues that does not have clear edge, such as, for example, where two types of tissue merge one to the other). Deformable models are curves or surfaces defined within an image domain that can move under the influence of internal forces, (that are defined within the curve or surface itself), and external forces (that are computed from the image data). The internal forces are designed to keep the model smooth during deformation. The external forces are defined to move the model toward an object boundary or other desired features within an image. By constraining extracted boundaries to be smooth and incorporating additional prior information/knowledge about the shape of the object, deformable models offer robustness to both image noise and boundary gaps and allow integrating boundary elements into a coherent and consistent mathematical description. In general, there are basically two types of deformable models: parametric deformable models and geometric deformable models. Parametric deformable models represent curves and surfaces explicitly in their parametric forms during deformation. This representation allows direct interaction with the model and can lead to a compact representation for fast real-time implementation. Adaptation of the model topology, however, such as splitting or merging parts during the deformation, may be difficult using parametric models. On the other hand, geometric deformable models can handle topological changes naturally. These models represent curves and surfaces implicitly as a level set of a higher-dimensional scalar function. Object boundaries may be represented by a 2-simplex mesh comprising a finite set of vertices, edges, and faces. An initial mesh is plunged in a domain of the 3D image and then deformed in order to find the correct boundaries of the object to segment. As mentioned above, the deformation process itself involves two kinds of forces: internal forces adapted to regularize the mesh under some given constraints (for example, to keep the mesh smooth), and external forces adapted to attract mesh vertices towards image features of interest. Internal forces generally depend on position of the vertices, while external forces usually depend on image information. Additional information may be found in H. Delingette, “General Object Reconstruction Based on Simplex Meshes”, International Journal of Computer Vision, 32(2):111-146, 1999, incorporated herein by reference in its entirety.

Mesh deformation is governed by a second order (Newtonian) evolution equation. External forces may be based on image gradients (vessel boundaries) and texture boundaries. The deformation is carried out using a hierarchical mesh (moving from a coarse mesh with a small number of vertices to refined mesh with a large number of vertices, with small distances between the vertices). This allows for fast and rough segmentation of large and medium arteries at initial stages, and accurate, relatively slow refinement of the result of the initial stages, and the segmentation of small arteries.

In accordance with an embodiment of the disclosure, 3D deformable models segmentation 520 starts with an initial mesh, for example, a sphere, and evolves (deforms) from the initial mesh to create a final mesh, delineating the segmented object surfaces. Optionally, the initial mesh may have other geometrical shapes, such as rectangular, elliptical, or other polygonal shape suitable for mesh deformation. 3D deformable models segmentation 520 comprises the following steps: Mesh properties 521, Mesh Regularization 522, Mesh Deformation 523. External Forces 524, and Hierarchical Segmentation 525. In accordance with some embodiments of the disclosure, the steps are not shown in any particular sequence as the segmentation process may be iterative with some steps being performed a plurality of times, and not necessarily one step after another.

[STEP 521] Mesh Properties:

In this step mesh object boundaries are represented by the 2-simplex mesh.

[STEP 522] Mesh Regularization:

This step comprises changing the amount and/or organization of vertices on the mesh without changing the mesh shape. A mesh, or parts of a mesh, may be refined or decimated by regularizing cell shape (edge swapping) and/or by repartitioning cells on the mesh surface in order to better fit the local curvature. The mesh may be resampled to a given resolution and with a given tolerance. The segmentation usually requires keeping a given resolution, through automatic mesh adaptation, during the deformation process. Regularization may be used to create the following:

a. a refined mesh which comprises more vertices, and smaller edge lengths, adapted to generate a more accurate estimate of object surface;

b. a coarse mesh which comprises less vertices and larger edge lengths, allowing for faster processing;

c. a regularized mesh which comprises edge swapping to achieve a given resolution, with a given tolerance; and

c. mesh repair which comprises identification and closure of holes and identification and removal of mesh crossings. Mesh deformation may create holes in the mesh surface throughout the mesh deformation process, which may require closing in order to achieve correct segmentation. Additionally, the mesh may cross itself, creating a non-physical segmentation, which may complicate the segmentation process.

[STEP 523] Mesh Deformation:

In this step, mesh deformation is typically carried out using forces acting on the vertices. The forces comprise internal forces (internal constraints), and external forces. Two main internal forces are curvature continuity and shape memory constraints. Curvature continuity generally uses local curvature estimation and is adapted to smooth a local curvature in a given topological neighborhood. Shape memory constraints are adapted to restore a given shape, or a general regional shape, such as a tubular or spherical shape of a vertex region.

The deformation process comprises applying external forces vertex by vertex, and may include, in accordance with some embodiments of the disclosure, one or more of the following features:

a. mesh cutting prevention adapted to prevent the external forces from searching image features “through” the mesh, preventing the mesh from traversing itself;

b. mesh deformation stopping—wherein the deformation process can be stopped either manually (by setting a maximal number of iterations) or using an automatic convergence mechanism. Optionally, so as to increase computational efficiency, mesh automatic freezing may be activated wherein non-evolving mesh vertices or entire mesh parts are “frozen” and do not continue to participate in mesh deformation; and

c. mesh to binary volume—wherein, at the end of the deformation process, the mesh may be transformed into scan volume voxels so that the voxels may be optionally enhanced later on. This may be carried out using a geometrical conversion algorithm adapted to define which voxels are inside the mesh and which voxels are outside the mesh and accordingly define the scan volume.

[STEP 524] External Forces:

As previously mentioned above, mesh deformation is generally carried out using forces acting on the vertices. Several forces may be applied simultaneously, and optionally, a same force may be used with different parameters. In some embodiments, the deformation may comprise several stages, each having its own set of forces and each with its own set of parameters tuned to that stage. The external forces generally act along the normal of the vertex, since movement orthogonal to the normal does not deform the mesh but moves the vertex on the mesh surface.

The external forces used in the segmentation process include the following forces, each of which, in accordance with some embodiments of the disclosure, may be used individually or combination with one or more of the other external forces:

a. CT Values, which comprises a force adapted to substantially fit a vertex to the boundary of an object defined by CT values. The CT values may include an upper threshold and/or a lower threshold. According to some embodiments, the CT values may be measured, for example, in units of intensity, HU, and the like.

b. Gradient Force, which comprises a force adapted to fit the mesh to the gradient local maxima, under the assumption that object boundaries are represented by relatively strong image gradients (or edges). The gradient may be computed in advance, before, or while the deformation takes place;

c. Texture Force, which comprises a force adapted to fit the mesh to areas of substantially similar texture. The force mechanism may be similar to that of the CT value or gradient force, but instead of acting on the original CT scanned volume, it acts on a texture map of the volume, describing texture features or classes of each voxel;

d. Vesselness Force, which comprises a force adapted to calculate a vesselness of a group of pixels, such as in an analysis of eigen values of a Hessian matrix as described above. The force will generally allow propagation of a mesh into regions that are considered as having a relatively high vesselness measure; and

e. Adaptive J-value force which comprises a force adapted to substantially minimize the J-value of an image, where the J-value represents the variance of the pixels in the image. A J-value that tends to zero usually indicates that the pixels are homogenous. The J-value will tend to zero when calculated over regions substantially containing a same tissue, for example blood with contrast inside a blood vessel, or the liver parenchyma. J-value will tend to increase in regions where there are two kinds of tissues, for example, in an area that includes pixels from blood vessels and surrounding air inside bronchioles. The J-value force will move a vertex to the relatively best location along the vertex normal where the J-value is minimal (keep its tendency to zero), thus substantially assuring that the mesh encapsulates only blood and contrast regions.

[STEP 525] Hierarchical Segmentation:

In accordance with an embodiment of the disclosure, the use of a hierarchical segmentation model provides for a relatively fast and effective segmentation method. The segmentation method is divided into several stages each stage comprising its own mesh resolution (going from coarse to fine), its combination of forces, and its forces' parameters, and its own active set of vertices (for example, some vertexes are frozen in each stage).

At each stage the mesh comprises the following characteristics:

a. Mesh resolution: a coarse resolution is first applied followed by a fine resolution. The coarse resolution comprises a large edge size which allows for a substantially faster growing process that is less sensitive to noise, but decreases in accuracy, and is relatively unable to segment small structures. The fine resolution comprises a small edge size that results in a substantially better segmentation and ability to segment tiny structures, but the growing process is relatively slower and the noise sensitivity is relatively large when compared to the coarse resolution.

b. Forces parameters: in early stages the forces may use wider scales and relatively high movement speeds to achieve faster segmentation; followed in later stages by forces which use fine scales and slower movements to reach accurate edge locations, and substantially reduce oscillatory movements around the edges.

c. Forces combination: in early stages the forces used are less accurate but computationally inexpensive in order to capture the general shape of the object; followed in later stages by forces which are more accurate, but computationally expensive to segment, so as to substantially accurately extract from the object delicate borders.

In accordance with some embodiments of the disclosure, an exemplary hierarchical segmentation model is described for segmenting a vessel in the vicinity of the aorta. The hierarchical model starts with a small spherical mesh in the aorta. The initial mesh comprises a very coarse resolution; therefore it will only be able to segment large objects such as the aorta but cannot enter medium or small vessels. The forces used at this stage are computationally inexpensive forces such as gradient and CT value based forces. At the end of this stage, the image comprises vertices with large local curvatures, which delimitate the origin of medium size arteries. The next stage starts with finer resolution, allowing segmentation of medium size arteries and uses texture-based forces to segment medium size arteries. The third stage uses relatively better resolution with recalculation of the thresholds and texture values to extract small vessels. In the final stage substantially fine mesh resolution is used along with J-value forces to accurately extract the substantially better border locations.

In accordance with some embodiments, other segmentation methods/algorithms such as level sets and fast marching may be used. The level set segmentation method is a method for implementing geometric deformable models. Geometric deformable models are based on curve evolution theory and the level set method. In particular, curves and surfaces are evolved using only geometric measures, resulting in an evolution that is independent of the parameterization. The curve evolution is coupled with the image data to recover object boundaries. Since the evolution is independent of the parameterization, the evolving curves and surfaces can be represented implicitly as a level set of a higher-dimensional function. As a result, topology changes can be handled automatically. The geometric deformable model may be used to couple the speed of deformation (using curvature and/or constant deformation) with the image data, so that the evolution of the curve stops at object boundaries. The evolution is implemented using the level set method. In the level set method, the curve is represented implicitly as a level set of a 2D (3D) scalar function, referred to as the level set function, which is usually defined on the same domain as the image. The level set is defined as the set of points that have the same function value. The purpose of the level set function is to provide an implicit representation of the evolving curve. Instead of tracking a curve through time, the level set method evolves a curve by updating the level set function at fixed coordinates through time. This perspective is similar to that of an Eulerian formulation of motion as opposed to a Lagrangian formulation, which is analogous to the parametric deformable model. A useful property of this approach is that the level set function remains a valid function, while the embedded curve can change its topology. The evolution is similar to energy minimization of internal energy (internal forces) and potential energy (the external forces). The resulting curve minimizes the weighted sum of internal energy and potential energy. The internal energy specifies the tension or the smoothness of the contour. The potential energy is defined over the image domain and typically possesses local minima at the image intensity edges occurring at object boundaries. Minimizing the total energy yields equilibrium of internal forces and potential forces. The fast marching segmentation algorithm is a specific implementation of the Level Set method, where the growing process may have only one direction—growing either in or out. As with level set method, the fast marching algorithm segments a volume from the entire image. The fast marching algorithm is given a starting volume (which may originate from an initial point from which an initial volume is created, such as, for example, a small hyperspace cube/ball surrounding the starting point) that is contained within the desired volume of interest. On this initial volume, the boundary points are defined as the front of growing process. A speed image may be calculated to reflect the probability that each voxel is similar to its neighboring pixels rather than being an edge voxel (an example for speed image may include the inverse exponential of the image gradient magnitude). Given the speed image and the frontal boundary points, separating the volume of interest from the rest of the image, a time crossing value may be calculated for each boundary point by solving the Eikonal Equation. An example of an iterative algorithm may be deployed as follows: in each iteration, the boundary point with minimal time crossing value is added to the volume of interest and the time crossing values are re-calculated for the new neighbors. The algorithm may be stopped in certain iteration, or alternatively, the time crossing values may be calculated for the entire image, and then a threshold on the time crossing values may define which voxel belongs to the volume of interest and which is an outlier (artifact). Additional information regarding fast marching algorithm may be found in: “Level Set Methods and Fast Marching Methods Evolving Interfaces in Computational Geometry, Fluid Mechanics, Computer Vision, and Materials Science” by J. A. Sethian, Cambridge University Press, 1999, incorporated herein by reference in its entirety; and in: “Fast extraction of minimal paths in 3D images and applications to virtual endoscopy”, T. Deschamps and L. D. Cohen. Medical Image Analysis, 5(4):281-299, December 2001, incorporated herein by reference in its entirety. Additionally or alternately, other methods including region growing based on growing criteria similar to the forces criteria described above, or classification based segmentation such as JSEG (J-value segmentation), may be used.

According to some embodiments, the post processing stage comprises the following steps: Enhance arteries 509, Arteries and Vein Separation 510, and Special Organ Enhancement 511.

[STEP 509] Enhance Arteries:

In this step the previously segmented blood arteries are enhanced to achieve a desired conspicuity. All voxels previously identified as containing blood, are enhanced based on the original HU value of the voxel and the desired conspicuity, by setting the voxel HU to a higher value.

[STEP 510] Arteries and Veins Separation:

In this step the arteries and veins are identified and treated differently such that only the arteries are enhanced, or a different enhancement may be given to the veins and the arteries.

[STEP 511] Special Organ Enhancement:

In this step large body organs, such as for example, a liver and/or a kidney, which may be contrast enhanced and relatively indistinguishable from the arteries, are identified. Prior knowledge of organ locations, shapes, and HU values range may be used to identify the organs, and to segment them. The organs may then be removed.

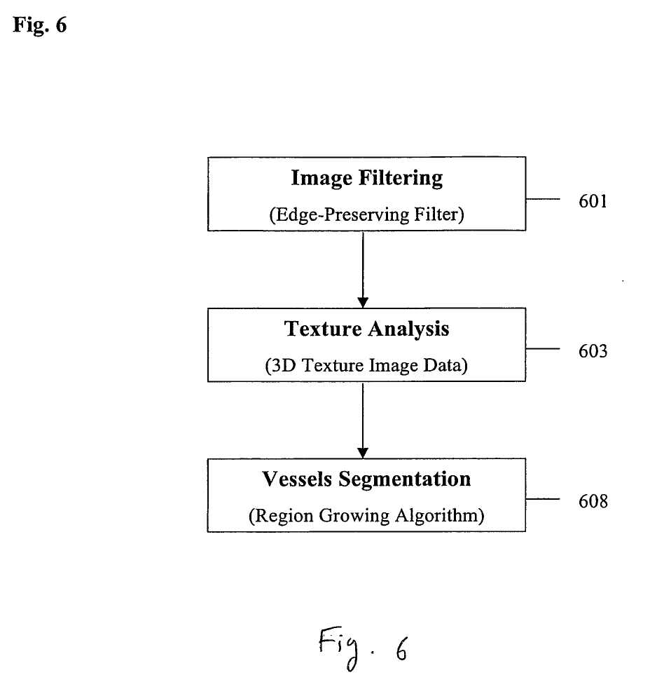

Reference is made to FIG. 6, which illustrates a flow diagram of a method of segmentation, in accordance with another embodiment of the disclosure. The method of segmentation may optionally be implemented as software or hardware, or any combination thereof, in image processing device 101 shown in FIG. 1, and/or optionally, in image processing device 50 shown in FIG. 2. Additionally, an image or series of images may be the same or substantially similar to images 200 shown in FIG. 2, and a vessel may be the same or substantially similar to vessel 300 shown in FIG. 3.

The method of segmentation comprises three steps, Image Filter (Edge Preserving Filter) 601, Texture Analysis (3D Texture Image Data) 603 and Vessels Segmentation (Region Growing Algorithm) 608, which may be the same as those steps shown in FIG. 5A and/or FIG. 5B at 501, 503 and 508, respectively.

According to some embodiments, the method of segmentation may be used to obtain clinically significant images from images that otherwise would have had poor diagnostic quality. The method may be used to obtain images created when using lower than routinely used amounts of contrast material, and create images that exhibit quality which is equivalent to the quality of images obtained when using high amounts of contrast material. For example, with regards to blood vessels, a scoring system for visualization of vessels has been presented by the European Guidelines on Quality Criteria for Computed Tomography (incorporated herein by reference, in its entirety). In general, the scoring system includes the following levels of quality: 1. Vascular structures not seen; 2. Poor but usable—wherein characteristic vascular features are detectable but details are not fully reproduced; 3. Good—allows an adequate assessment, details of vascular structures are visible but not necessarily clearly defined; 4. Very good—allows an excellent assessment, vascular details clearly defined. Thus, the method of segmentation may be used to obtain clinically significant images (such as at the level of score 3 to 4) from images that otherwise would have had poorly diagnostic quality (such as at the level of score 1 to 2).

In the description and claims of embodiments of the present disclosure, each of the words, “comprise” “include” and “have”, and forms thereof, are not necessarily limited to members in a list with which the words may be associated.

The disclosure has been described using various detailed descriptions of embodiments thereof that are provided by way of example and are not intended to limit the scope of the disclosure. The described embodiments may comprise different features, not all of which are required in all embodiments of the disclosure. Some embodiments of the disclosure utilize only some of the features or possible combinations of the features. Variations of embodiments of the disclosure that are described and embodiments of the disclosure comprising different combinations of features noted in the described embodiments will occur to persons with skill in the art.

1. A method of medical imaging of a structure comprising:
creating a three dimensional image of the structure; and
processing the image to enhance image quality such that images with an attenuation value below a threshold value result in a recognizable image, thereby identifying the structure.

2. The method of claim 1, wherein said creating a three dimensional image of the structure comprises creating a three dimensional texture image data of the structure.

3. The method of claim 2, wherein creating a three dimensional texture image data comprises using a J-value texture process, Gabor filter, Markov Random Field (MRF), Grey Level Co-occurrence Matrix (GL-CM), or any combination thereof.

4. The method of claim 1, further comprising processing by an edge-preserving filter that is adapted to smooth the image while essentially maintaining edges of the image.

5. The method of claim 4, wherein processing by an edge-preserving filter is performed prior to creating three dimensional texture image data.

6. The method of claim 4, wherein the edge-preserving filter comprises a Hybrid edge preserving algorithm (HEPA) filter.

7. The method of claim 6, wherein the HEPA filter comprises at least one algorithm from a peer group filter and/or a bilateral filter.

8. The method of claim 2, wherein the creation of a three dimensional texture image data is applied for at least a sub region of a volume data.

9. The method of claim 2, further comprising performing a region-growing algorithm on the three dimensional texture image data.

10. The method of claim 1, wherein a region-growing algorithm is adapted to grow the image while essentially remaining in a homogenous texture.

11. The method of claim 1, wherein a region-growing algorithm incorporates a geometrical tubular measure which is adapted to facilitate image growing substantially within tubular structures.

12. The method of claim 2, further comprising performing a differential geometry algorithm on the three dimensional texture image data.

13. The method of claim 1, wherein a differential geometry algorithm is adapted to grow the image while essentially remaining in a homogenous texture.

14. The method of claim 1, wherein a differential geometry algorithm incorporates a geometrical tubular measure which is adapted to facilitate image growing substantially within tubular structures.

15. The method of claim 1, wherein the structure comprises a blood vessel.

16. The method of claim 1, wherein the structure comprises: a body, body part, organ, tissue, cell, arrangement of tissues, arrangement of cells, or any combination thereof.

17. The method of claim 1, wherein said three dimensional image data comprises: a three dimensional volume data set, form of digital data, location of pixels, coordinates of pixels, distribution of pixels, intensity of pixels, vectors of pixels, location of voxels, coordinates of voxels, distribution of voxels, intensity of voxels, or any combination thereof.

18. The method of claim 1, wherein the medical imaging comprises Computerized Tomography (CT).

19. The method of claim 1, wherein the medical imaging comprises Magnetic Resonance Imaging (MRI).

20. The method of claim 1, wherein the medical imaging comprises: Ultrasound (US), Computerized Tomography Angiography (CTA), Magnetic Resonance Angiography (MRA), Positron Emission Tomography (PET), PET/CT, 2D-Angiography, 3D-Angiography, X-ray/MRI, or any combination thereof.

21. The method of claim 1, wherein the attenuation value is measured in Hounsfield units (HU).

22. The method of claim 1, wherein the threshold value is lower than about 200 HU.

23. The method of claim 1, further comprising administration of contrast material.

24. The method of claim 23, wherein said contrast material comprises: Iodine, radioactive isotope of Iodine, Gadolinium, micro-bubbles agent, or any combination thereof.

25. The method of claim 23, where said contrast material comprises molecular imaging contrast material.

26. The method of claim 25, wherein said molecular imaging contrast material comprises Glucose enhanced with iodine, liposomal iodixanol, technetium, deoxyglucose, or any combination thereof.

27. A device for medical imaging of a structure comprising:
an image processing module adapted to create a three dimensional image of a structure within the living tissue and to use image data correlated to the structure to enhance image quality such that an image with an attenuation value below a threshold value results in a recognizable image.

28. The device of claim 27, wherein said three dimensional image of a structure comprises a three dimensional texture image data of a structure.

29. The device of claim 27, comprising a J-value texture process, Gabor filter, Markov Random Field (MRF), Grey Level Co-occurrence Matrix (GL-CM), or any combination thereof, adapted to create a three dimensional texture image data.

30. The device of claim 27, further comprising an edge-preserving filter adapted to smooth the image while essentially maintaining edges of the image.

31. The device of claim 28, comprising an edge-preserving filter adapted to perform processing prior to the creation of the three dimensional texture image data.

32. The device of claim 27, comprising an edge-preserving filter and wherein the edge-preserving filter comprises a Hybrid edge preserving algorithm (HEPA) filter.

33. The device of claim 27, comprising a Hybrid edge preserving algorithm (HEPA) filter and wherein the HEPA filter comprises at least one algorithm from a peer group filter and/or a bilateral filter.

34. The device of claim 28, wherein the creation of a three dimensional texture image data can be applied for at least a sub region of a volume data.

35. The device of claim 28, comprising a region-growing algorithm adapted to be performed on the three dimensional texture image data.

36. The device of claim 27, comprising a region-growing algorithm adapted to grow the image while essentially remaining in a homogenous texture.

37. The device of claim 27, comprising a region-growing algorithm incorporating a geometrical tubular measure which is adapted to facilitate image growing substantially within tubular structures.

38. The device of claim 28, comprising a differential geometry algorithm adapted to be performed on the three dimensional texture image data.

39. The device of claim 27, comprising a differential geometry algorithm adapted to grow the image while essentially remaining in a homogenous texture.

40. The device of claim 27, comprising a differential geometry algorithm incorporating a geometrical tubular measure which is adapted to facilitate image growing substantially within tubular structures.

41. The device of claim 27, wherein the structure comprises a blood vessel.

42. The device of claim 27, wherein the structure comprises: a body, body part, organ, tissue, cell, arrangement of tissues, arrangement of cells, or any combination thereof.

43. The device of claim 28, wherein said three dimensional image data comprises: a three dimensional volume data set, form of digital data, location of pixels, coordinates of pixels, distribution of pixels, intensity of pixels, vectors of pixels, location of voxels, coordinates of voxels, distribution of voxels, intensity of voxels, or any combination thereof.

44. The device of claim 27, wherein the medical imaging comprises Computerized Tomography (CT).

45. The device of claim 27, wherein the medical imaging comprises Magnetic Resonance Imaging (MRI).

46. The device of claim 27, wherein the medical imaging comprises: Ultrasound (US), Computerized Tomography Angiography (CTA), Magnetic Resonance Angiography (MRA), Positron Emission Tomography (PET), PET/CT, 2D-Angiography, 3D-Angiography, X-ray/MRI, or any combination thereof.

47. The device of claim 27, wherein the attenuation value is measured in Hounsfield units (HU).

48. The device of claim 27, wherein the threshold value is lower than about 200 HU.

49. The device of claim 27, further comprising administration of contrast material.

50. The device of claim 49, wherein said contrast material comprises: Iodine, radioactive isotope of Iodine, Gadolinium, micro-bubbles agent, or any combination thereof.

51. The device of claim 49, where said contrast material comprises molecular imaging contrast material.

52. The device of claim 51, wherein said molecular imaging contrast material comprises Glucose enhanced with iodine, liposomal iodixanol, technetium, deoxyglucose, or any combination thereof.

53. A system for medical imaging of a structure comprising:
a scanning portion adapted to scan a living tissue; and
an image processing module adapted to create a three dimensional image of a structure within the living tissue and to use image data correlated to the structure to enhance image quality such that an image with an attenuation value below a threshold value results in a recognizable image.

54. The system of claim 53, wherein said three dimensional image of a structure comprises three dimensional texture image data of a structure.

55. The system of claim 53, comprising a J-value texture process, Gabor filter, Markov Random Field (MRF), Grey Level Co-occurrence Matrix (GL-CM), or any combination thereof, adapted to create a three dimensional texture image data.

56. The system of claim 53, further comprising an edge-preserving filter adapted to smooth the image while essentially maintaining edges of the image.

57. The system of claim 53, comprising an edge-preserving filter adapted to perform processing prior to the creation of the three dimensional texture image data.

58. The system of claim 53, comprising an edge-preserving filter and wherein the edge-preserving filter comprises a Hybrid edge preserving algorithm (HEPA) filter.

59. The system of claim 53, comprising a Hybrid edge preserving algorithm (HEPA) filter and wherein the HEPA filter comprises at least one algorithm from a peer group filter and/or a bilateral filter.

60. The system of claim 54, wherein the creation of a three dimensional texture image data is applied to at least a sub region of a volume data.

61. The system of claim 54, comprising a region-growing algorithm adapted to be performed on the three dimensional texture image data.

62. The system of claim 53, comprising a region-growing algorithm adapted to grow the image while essentially remaining in a homogenous texture.

63. The system of claim 53, comprising a region-growing algorithm incorporating a geometrical tubular measure which is adapted to facilitate image growing substantially within tubular structures.

64. The system of claim 54, comprising a differential geometry algorithm adapted to be performed on the three dimensional texture image data.

65. The system of claim 53, comprising a differential geometry algorithm adapted to grow the image while essentially remaining in a homogenous texture.

66. The system of claim 53, comprising a differential geometry algorithm incorporating a geometrical tubular measure which is adapted to facilitate image growing substantially within tubular structures.

67. The system of claim 53, wherein the structure comprises a blood vessel.

68. The system of claim 53, wherein the structure comprises: a body, body part, organ, tissue, cell, arrangement of tissues, arrangement of cells, or any combination thereof.

69. The system of claim 54, wherein said three dimensional image data comprises: a three dimensional volume data set, form of digital data, location of pixels, coordinates of pixels, distribution of pixels, intensity of pixels, vectors of pixels, location of voxels, coordinates of voxels, distribution of voxels, intensity of voxels, or any combination thereof.

70. The system of claim 53, wherein the medical imaging comprises Computerized Tomography (CT).

71. The system of claim 53, wherein the medical imaging comprises Magnetic Resonance Imaging (MRI).

72. The system of claim 53, wherein the medical imaging comprises: Ultrasound (US), Computerized Tomography Angiography (CTA), Magnetic Resonance Angiography (MRA), Positron Emission Tomography (PET), PET/CT, 2D-Angiography, 3D-Angiography, X-ray/MRI, or any combination thereof.

73. The system of claim 53, wherein the attenuation value is measured in Hounsfield units (HU).

74. The system of claim 53, wherein the threshold value is lower than about 200 HU.

75. The system of claim 53, further comprising administration of contrast material.

76. The system of claim 75, wherein said contrast material comprises: Iodine, radioactive isotope of Iodine, Gadolinium, micro-bubbles agent, or any combination thereof.

77. The system of claim 75, where said contrast material comprises molecular imaging contrast material.

78. The system of claim 77, wherein said molecular imaging contrast material comprises Glucose enhanced with iodine, liposomal iodixanol, technetium, deoxyglucose, or any combination thereof.
